(19) United States
(12) Patent Application Publication
(10) Pub. No.: US 2026/0089064 A1
(43) Pub. Date: Mar. 26, 2026

(54) DATA COLLECTION COORDINATION FUNCTION AND NETWORK DATA ANALYTICS FUNCTION FRAMEWORK FOR SENSING SERVICES IN NEXT GENERATION CELLULAR NETWORKS

(71) Applicant: INTEL CORPORATION, Santa Clara, CA (US)

(72) Inventors: Zongrui DING, Portland, OR (US); Qian LI, Portland, OR (US); Meghashree Dattatri KEDALAGUDDE, Portland, OR (US); Alexandre Saso STOJANOVSKI, Paris (FR); Fatemeh HAMIDI-SEPEHR, San Jose, CA (US); Thushara HEWAVITHANA, Chandler, AZ (US); Thomas LUETZENKIRCHEN, Taufkirchen (DE); Abhijeet KOLEKAR, Leander, TX (US); Sudeep PALAT, Cheltenham (GB); Youn Hyoung HEO, Seoul (KR); Sangeetha BANGOLAE, Portland, OR (US)

(73) Assignee: INTEL CORPORATION, Santa Clara, CA (US)

(21) Appl. No.: 19/108,719

(22) PCT Filed: Sep. 26, 2023
(86) PCT No.: PCT/US2023/075158

§ 371 Date: Mar. 4, 2025

Related U.S. Application Data
(60) Provisional application No. 63/412,786, filed on Oct. 3, 2022.

(51) Int. Cl. H04L 41/14; H04L 41/0853

(52) U.S. Cl. CPC H04L 41/14; H04L 41/0853

(57) ABSTRACT

This disclosure describes systems, methods, and devices related to sensing service coordination. A device may discover a Network Data Analytics Function (NWDAF) via a Network Function Repository Function (NRF). The device may send an Analytics request or subscribe to the selected NWDAF with a criteria based on a sensing data analytics ID, event ID, and event parameters. The device may select a Data Collection Coordination Function (DCCF) instance when DCCF is used for data collection, based on DCCF Serving Area Information. The device may receive sensing data or data analytics from the NWDAF after NWDAF has processed the data collected from DCCF.

### CROSS-REFERENCE TO RELATED PATENT APPLICATION(S)

This application claims the benefit of U.S. Provisional Application No. 63/412,786, filed Oct. 3, 2022, the disclosure of which is incorporated herein by reference as if set forth in full.

### TECHNICAL FIELD

This disclosure generally relates to systems and methods for wireless communications and, more particularly, to data collection coordination function (DCCF)/network data analytics function (NWDAF) framework for sensing services in next generation cellular networks.

### BACKGROUND

The Data Collection Coordination Function (DCCF) and Network Data Analytics Function (NWDAF) are crucial components in modern telecommunications infrastructure, designed to oversee network performance and user equipment (UE) related data collection and analytics. However, the current framework is narrowly focused and excludes a category of valuable information: sensing data. As networks evolve, sensing data becomes increasingly important for applications such as IoT, autonomous vehicles, and smart cities. While the existing DCCF and NWDAF models excel in gathering and analyzing metrics related to network efficiency and UE behavior, they lack a standardized interface for integrating sensing data. This omission represents a significant gap, underscoring the need for an enhanced framework that can seamlessly integrate this vital category of data into existing models.

### BRIEF DESCRIPTION OF THE DRAWINGS

FIGS. 1-7 depict illustrative schematic diagrams for sensing service coordination, in accordance with one or more example embodiments of the present disclosure.

FIG. 8 illustrates a flow diagram of a process for an illustrative sensing service coordination system, in accordance with one or more example embodiments of the present disclosure.

FIG. 9 illustrates an example network architecture, in accordance with one or more example embodiments of the present disclosure.

FIG. 10 schematically illustrates a wireless network, in accordance with one or more example embodiments of the present disclosure.

FIG. 11 illustrates components of a computing device, in accordance with one or more example embodiments of the present disclosure.

FIG. 12 illustrates a network in accordance with various embodiments.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The data collection coordination function (DCCF) and network data analytics function (NWDAF) framework is specified with different analytics and events defined, which does not include sensing data. The current DCCF and NWDAF framework is mainly specified to collect network performance data and UE related data. It does not provide standardized interface to handle sensing related data. Therefore, there is a need for an enhanced framework that can integrate sensing data into the existing DCCF and NWDAF models.

Example embodiments of the present disclosure relate to systems, methods, and devices for DCCF/NWDAF framework for Sensing Services in Next Generation Cellular Networks.

This disclosure provides solutions to at least the following scenarios.
The architecture for sensing service management function (SSMF) to interface data collection coordination function (DCCF) and network data analytics function (NWDAF), Analytics Data Repository Function (ADRF).
The information exchanged between SSMF, DCCF and NWDAF to identify sensing data and related data filters.
The message flows for the sensing data to be collected, transferred, processed and fetched using DCCF and NWDAF framework.

In one embodiment, a sensing service coordination system may facilitate that the sensing service related identifiers and information elements (IEs), i.e., analytics ID, sensing data filter and sensing event IDs were defined for SSMF to leverage NWDAF/DCCF framework to collect, process, transfer, and retrieve sensing data. Example message flows are provided between SSMF and NWDAF, DCCF and ADRF via the newly defined interfaces NS5, NS6 and NS7. An advantage of the sensing service coordination system is that the cloudification of the telecommunication networks requires additional computing infrastructure.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

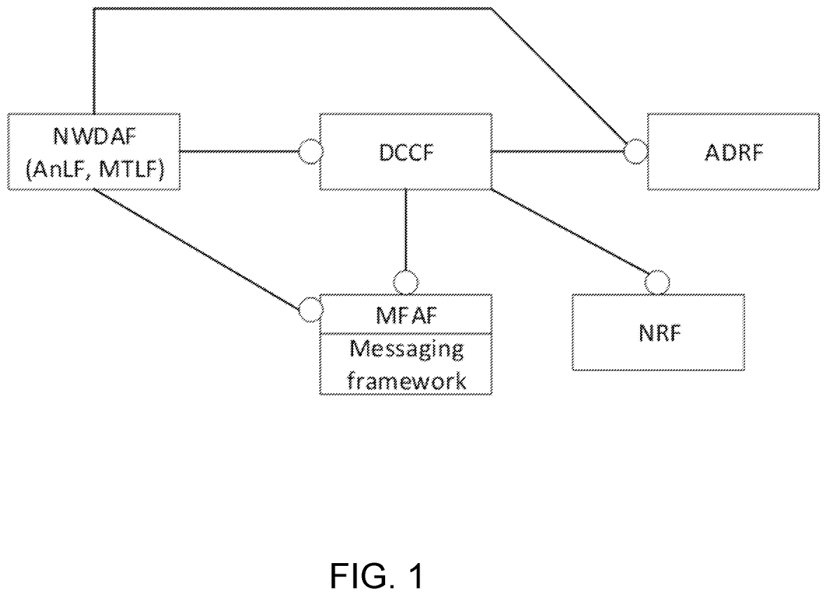

FIG. 1 depicts an illustrative schematic diagram for sensing service coordination, in accordance with one or more example embodiments of the present disclosure.

Referring to FIG. 1, there is shown the Architecture for DCCF/NWDAF data related functions.

In 3GPP SA1, three use cases for sensing services have been agreed for rel-19 and beyond including smart home, animal detection on highway and weather monitoring. To enable sensing service, a sensing service management function (SSMF) may be used to hold the sensing service logic, algorithms, policies and configurations. SSMF interfaces with RAN via AMF or a newly defined service based interface (SBI) named NS2 to exchange sensing related data and notifications.

To decide the data and its amount exchanged between RAN and CN, studies based on typical KPI requirements about the sensing service and processing pipelines show that the data amount can be very high per beam per frame up to G bits to T bits if RAN would send the intermediate processing results to CN. On the other hand, sensing data is very valuable in producing different results, ranging from the basic sensing objectives including detecting objects to objects' shape identification and movement tracking (which are more advanced objectives usually achievable through advanced post processing). All such processing, usually requires a large amount of sensing data. Analytics can be generated based on applying AI/ML or post-processing the sensing data. Therefore, the DCCF/NWDAF framework can be leveraged for sensing data collection, transfer, post-processing, and delivery.

As defined in TS 23.288 Architecture enhancements for 5G System (5GS) to support network data analytics services, NWDAF includes two functions: Analytics logical function (AnLF) and Model Training logical function (MTLF). NWDAF can optionally include one or both functions. The DCCF is responsible for data collection, which could potentially prevent the same data from being collected multiple times, hold data registry, preprocess collected data, etc. DCCF/NWDAF can also work with the Analytics Data Repository Function (ADRF) to store the data and the messaging framework to efficiently deliver data via an adaptor function Messaging Framework Adaptor Function (MFAF). The architecture for these functions is captured in FIG. 1.

In some embodiments, network data analytics are identified by analytics ID and related information as shown in Table below (Table 7.1-2).

| Analytics | | |
|---|---|---|
| Information | Request Description | Response Description |
| Slice Load level | Analytics ID: load level information | Load level provided as number of UE |
| information | | registrations and number of PDU sessions for a |
| | | Network Slice and Network Slice instances as |
| | | well as resource utilization for Network Slice |
| | | instances. |
| Observed Service | Analytics ID: Service Experience | Observed Service experience statistics or |
| experience | | predictions may be provided for a Network Slice |
| information | | or an Application. They may be derived from an |
| | | individual UE, a group of UEs or any UE. For |
| | | slice service experience, they may be derived |
| | | from an Application, a set of Applications or all |
| | | Applications on the Network Slice. |
| NF Load information | Analytics ID: NF load information | Load statistics or predictions information for |
| | | specific NF(s). |
| Network | Analytics ID: Network Performance | Statistics or predictions on the load in an Area of |
| Performance | | Interest; in addition, statistics or predictions on |
| information | | the number of UEs that are located in that Area of |
| | | Interest. |
| UE mobility | Analytics ID: UE Mobility | Statistics or predictions on UE mobility. When |
| information | | visited AOI(s) is included in the Analytics Filter |
| | | information, only statistics on UE mobility can be |
| | | provided. |
| UE Communication | Analytics ID: UE Communication | Statistics or predictions on UE communication. |
| information | | |
| Expected UE | Analytics ID: UE Mobility and/or UE | Analytics on UE Mobility and/or UE |
| behavioural | Communication | Communication. |
| parameters | | |
| UE Abnormal | Analytics ID: Abnormal behaviour | List of observed or expected exceptions, with |
| behaviour | | Exception ID, Exception Level and other |
| information | | information, depending on the observed or |
| | | expected exceptions. |
| User Data | Analytics ID: User Data Congestion | Statistics or predictions on the user data |
| Congestion | | congestion for transfer over the user planc, for |
| information | | transfer over the control plane, or for both. |
| QoS Sustainability | Analytics ID: QoS Sustainability | For statistics, the information on the location and |
| | | the time for the QoS change and the threshold(s) |
| | | that were crossed: or, for predictions, the |
| | | information on the location and the time when a |
| | | potential QoS change may occur and what |
| | | threshold(s) may be crossed. |
| Session Management | Analytics ID: Session Management | Statistics on session management congestion |
| Congestion Control | Congestion Control Experience | control experience for specific DNN and/or S- |
| Experience | | NSSAI. |
| Redundant | Analytics ID: Redundant Transmission | Statistics or predictions aimed at supporting |
| Transmission | Experience | redundant transmission decisions for URLLC |
| Experience | | services. |
| WLAN performance | Analytics ID: WLAN performance | Statistics or predictions on WLAN performance |
| | | of UE. |
| Dispersion | Analytics ID: UE Dispersion | Statistics or predictions that identify the location |
| | | (e.g. areas of interest) or network slice(s) where a |
| | | UE, or a group of UEs disperse their data volume, |
| | | or disperse mobility or session management |
| | | transactions or both. |
| DN Performance | Analytics ID: DN Performance | Statistics or predictions on user plane |
| | | performance for a specific Edge Computing |
| | | application. |

Among other things, embodiments of the present disclosure are directed to providing solutions to the following:
The architecture for SSMF to interface DCCF and NWDAF, ADRF.
The information exchanged between SSMF, DCCF, and NWDAF to identify sensing data and related data filters.
The message flows for the sensing data to be collected, transferred, processed, and fetched using the DCCF and NWDAF framework.

The DCCF and NWDAF framework is specified in TS 23.288 with different analytics and events defined, which does not include sensing data. Moreover, the current DCCF and NWDAF framework is mainly specified to collect network performance data and UE related data. It does not provide standardized interface to handle sensing related data. Embodiments of the present disclosure address these and other issues.

Some embodiments of this disclosure are directed to the sensing service related identifiers and IEs, e.g., analytics ID, sensing data filter, and sensing event IDs were defined for SSMF to leverage NWDAF/DCCF framework to collect, process, transfer, and retrieve sensing data. Example message flows are provided between SSMF and NWDAF, DCCF, and ADRF via the newly defined interfaces NS5, NS6, and NS7.

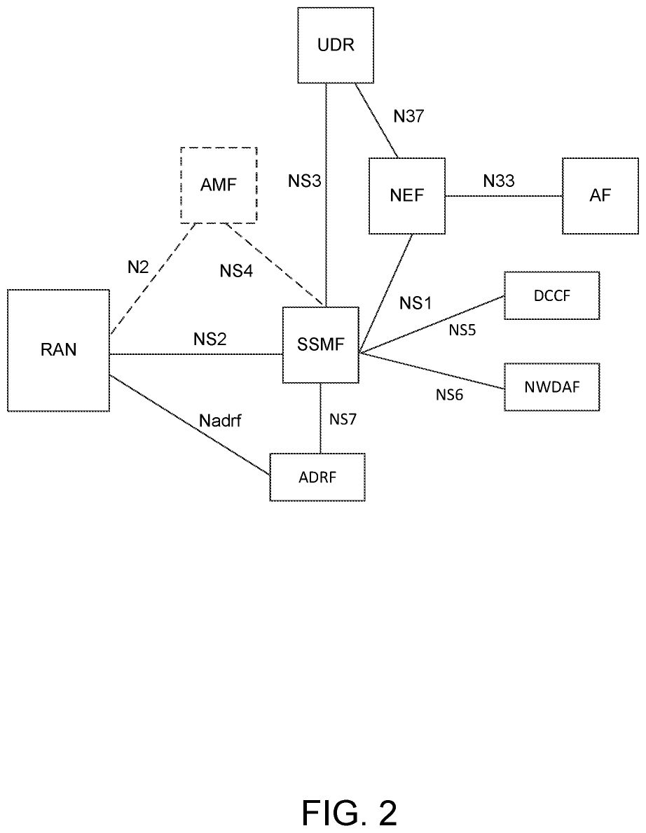

FIG. 2 depicts an illustrative schematic diagram for sensing service coordination, in accordance with one or more example embodiments of the present disclosure.

Referring to FIG. 2, there is shown reference architecture for sensing service.

Architecture for sensing data collection, delivery and processing using DCCF/NWDAF framework:

In some embodiments, a sensing service management function (SSMF) may be used to control sensing services that interface with RAN via AMF or a new SBI called NS2. In some embodiments, the interface between SSMF and DCCF, SSMF and NWDAF, SSMF and ADRF are named NS5, NS6, and NS7, respectively. RAN interfaces with ADRF via Nadrf or via N2 through AMF. In different embodiments, RAN can:
connect to the client node (CN) service-based architecture (SBA) via N2′ which is a SBI enhanced from N2, so that RAN can consume ADRF services.
connect to a collocated ADRF in RAN via NADRF.
connect to a new service based interface (SBI) between RAN and ADRF to consume ADRF services while N2 is as is.

Similar to CN SBA, producer functions register to NRF about its services with related parameters, and identifiers introduced below so that the consumer function can discover a service or analytics producer using the identifiers, data and analytics filters.

### Sensing Data Identifiers:

Sensing data identifiers such as analytics ID, sensing event ID, sensing data filters are the information to describe, provide metadata for, and retrieve sensing data. A new analytics ID (or multiple): sensing service is added as an additional analytics ID for sensing data in NWDAF shown in bold below.

| Analytics | | |
|---|---|---|
| Information | Request Description | Response Description |
| Slice Load level | Analytics ID: load level | Load level provided as number of UE |
| information | information | registrations and number of PDU sessions |
| | | for a Network Slice and Network Slice |
| | | instances as well as resource utilization |
| | | for Network Slice instances. |
| . . . | . . . | . . . |
| Sensing Service | Analytics ID: Sensing Service | Sensing data at different processing |
| data | | stages based on location, time window, |
| | | frequency, update rate, detection |
| | | angle, etc. |

Note that there can be multiple analytics IDs related to sensing services based on different use cases, which is out of the scope of this disclosure.

The sensing data filter parameters are also defined to collect, describe and retrieve the sensing data and analytics. These sensing data parameters can also be called as metadata for sensing service and can be used by DCCF for data collection, ADRF for data storage, NWDAF for analytics related processing, etc.

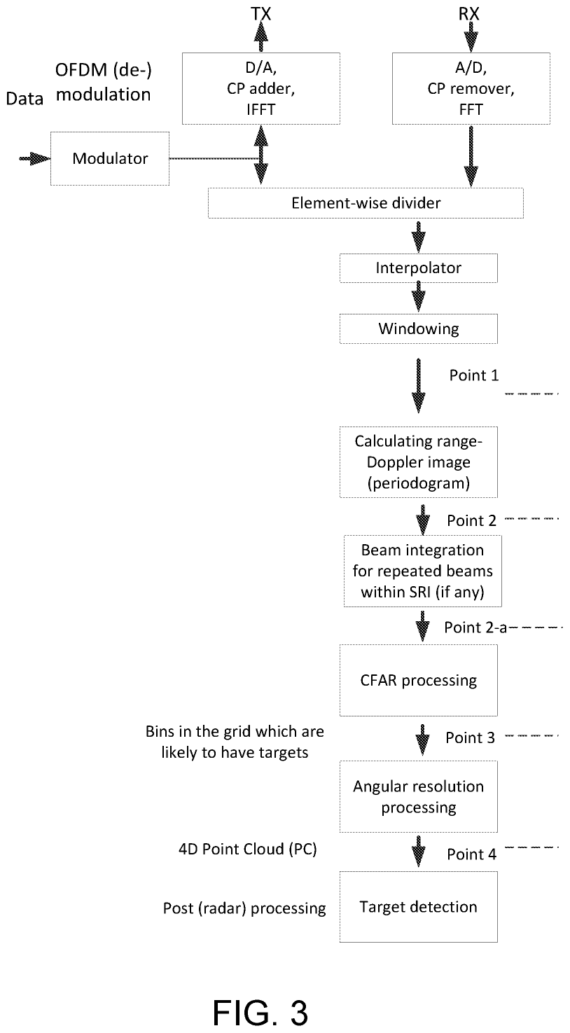

TABLE 1
Metadata for Sensing Service:

| Parameter | Description |
|---|---|
| Covered Location | The location of the sensing job, e.g., may be defined as a center point |
| | (latitude, longitude) and radius, angle from the center |
| Mode | NW based or UE based |
| Time stamp | Time when the data is collected |
| update rate | How often the sensing job is repeated |
| Sender location | The sender location of the sensing signal |
| Receiver location | The receiver location of the sensing signal |
| Field of view | The field of view of the sensing signal |
| Sensing resolution | Precision of Sensing |
| Data type | The data type, processing point at collection, refer to FIG. 3 |
| Data amount | The total amount of data |
| Recommended | Object detection |
| purpose | Object range/speed/angular estimation |
| | Object tracking |
| | Object shape identification |
| Confidence level | The confidence level of the data |

Sensing event IDs need to be defined to allow other NFs to be notified about the events and request data for a specific event related to sensing, which are listed as Table 2. The event notifications can be sent among RAN, SSMF and NWDAF/DCCF/ADRF/NRF and work as a trigger for other processes. The example consumers are also listed below.

TABLE 2
Event IDs for Sensing Service:

| | Event | | | |
|---|---|---|---|---|
| | parameter | | | Example |
| Event | name | Parameter values | Attributes | consumer NF |
| Sensing target | Sensing target | Detected | indicator for | SSMF, DCCF, |
| status update | indicator | Not detected | whether target is | NWDAF |
| | | Detection error | detected or not | |
| Sensing target | Sensing target | Sensing target move in | Indicate sensing | SSMF, DCCF, |
| mobility | movement | or out of a region | target moves to a | NWDAF |
| | | | different region | |
| | | | Indicate sensing | |
| | | | target moves into | |
| | | | the region | |
| Sensing | Sensing | 1. The required sensing | Indicate changes in | RAN, SSMF |
| configuration | configuration | KPIs, e.g., | any of the sensing | |
| update | update | Update rate | related | |
| | | Max detectable speed | configurations | |
| | | Max detectable range | | |
| | | Field of view and/or | | |
| | | angle of view | | |
| | | Speed resolution | | |
| | | Range resolution | | |
| | | Angular resolution | | |
| | | Speed, range, angular | | |
| | | detection accuracy | | |
| | | 2. The sensing reference | | |
| | | signal configuration | | |
| | | Note: From KPIs, | | |
| | | sensing reference signal | | |
| | | attributes is derived and | | |
| | | configured. Still, the | | |
| | | sensing reference signal | | |
| | | configuration can be | | |
| | | separately listed | | |
| | | 3. Sensing measurement | | |
| | | (or data) collection point | | |
| | | (processing stage) | | |
| Sensing capability | Sensing | Sensing precision, update | | SSMF, AF |
| update | capability | rate, data processing | Indicate change in | |
| | | stage | sensing capability | |
| | | | of RAN | |
| Sensing QoS | Sensing service | Sensing precision, update | Indicate change of | SSMF, AF, |
| update | QoS | rate | required sensing | RAN |
| | | | service QoS | |

FIG. 3 depicts an illustrative schematic diagram for sensing service coordination, in accordance with one or more example embodiments of the present disclosure.

Referring to FIG. 3, there is shown an example of sensing target detection receiver processing.

Message flows for Sensing Data Collection and Delivery:

### Sensing Data Storage:

The current DCCF/NWDAF framework does not limit where data should be stored. Based on the network deployment, a NWDAF and ADRF may be co-located or they may be two separate network functions communicating via the Nadrf interface. The consumer NF e.g., NWDAF or DCCF requests the ADRF to store data or analytics. In this disclosure, the sensing data or sensing data analytics can be stored in ADRF or NWDAF. Different functions can trigger data collection such as RAN, NWDAF, and SSMF. If the NWDAF is the producer of the sensing data analytics, then based on the Sensing Data Analytic request from the NF consumer, the NWDAF initiates data collection either by directly subscribing to the producer of the data or via the DCCF. The sensing data collection by SSMF is out of the scope of this disclosure.

Sensing Data Storage in ADRF Directly without DCCF:

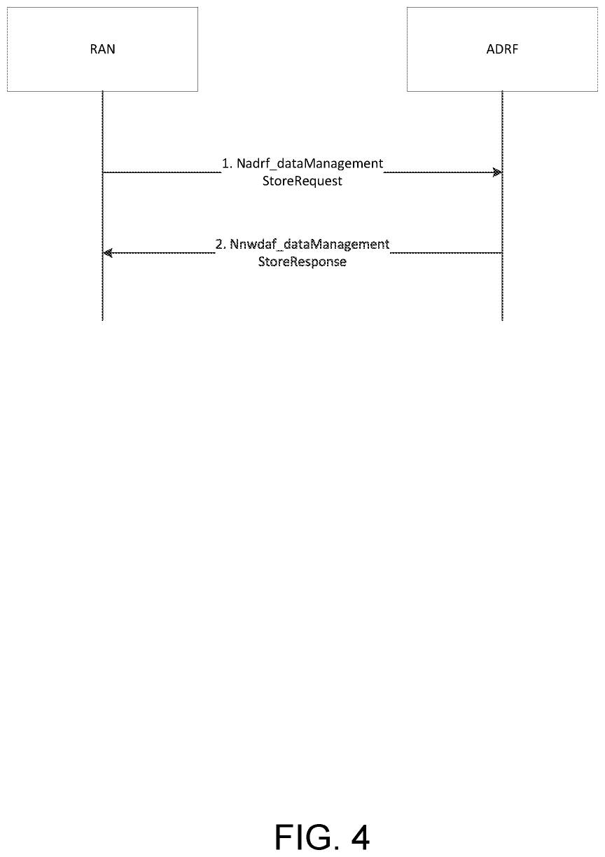

ADRF can collect and store sensing data without DCCF as shown in FIG. 4 Error! Reference source not found. In certain embodiments, an ADRF can be co-located with RAN. When ADRF is a network function in the CN, the RAN may connect to ADRF via a SBI (Nadrf). In this option, RAN initiates the transfer of sensing data.

Referring to FIG. 4, there is a RAN request ADRF to store sensing-related data via Nadrf

1) RAN sends a Nadrf_dataManagement_StoreRequest or Nadrf_dataManagemetn_StorageSubscriptionRequest to ADRF to request or subscribe to storing the sensing data. This message shall include the metadata for the sensing data.
a. sensing service together with the event ID as described in Table 2 if this store is triggered by an event
b. The metadata to describe the sensing data

2) ADRF sends a Nadrf_dataManagement_StoreResponse or Nadrf_dataManagemetn_StorageSubscriptionResponse to indicate whether the storing or the subscription of the sensing data is successful.

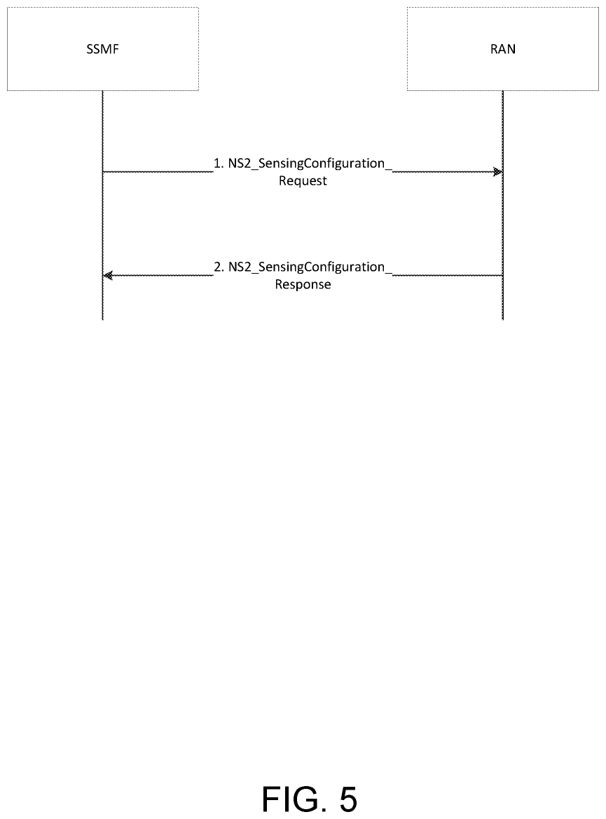

SSMF can set up sensing data collection by ADRF as part of the sensing configuration process as shown in FIG. 5.

Referring to FIG. 5, there is shown a sensing data collection configuration by SSMF.

1) SSMF sends an NS2 sensingConfiguration request to RAN which includes the data collection instructions. Besides the configuration related parameters (out of the scope of this disclosure), this message shall include how the sensing data needs to be collected, analytics ID (analytics for which data collected is requested or required), reporting threshold, data storage endpoint (exampleADRF), data collection target period (when to start and stop data collection) and the sensing events SSMF subscribes to and how to store the sensing data. In one example, SSMF can instruct RAN to store the sensing data with a filter as described in Table 2 to be stored directly to ADRF with an ADRF identifier such as IP address, function ID, URI, etc. RAN can also indicate the sensing data storage capability when registering the sensing capabilities to SSMF.

2) RAN sends a NS2_sensingConfiguration_response to SSMF to indicate the results of the configuration.

### Sensing Data Collection by DCCF:

SSMF can request sensing data collection through DCCF which will further request data collection at RAN as shown in FIG. 5. Note that multiple BSs or UEs can be involved.

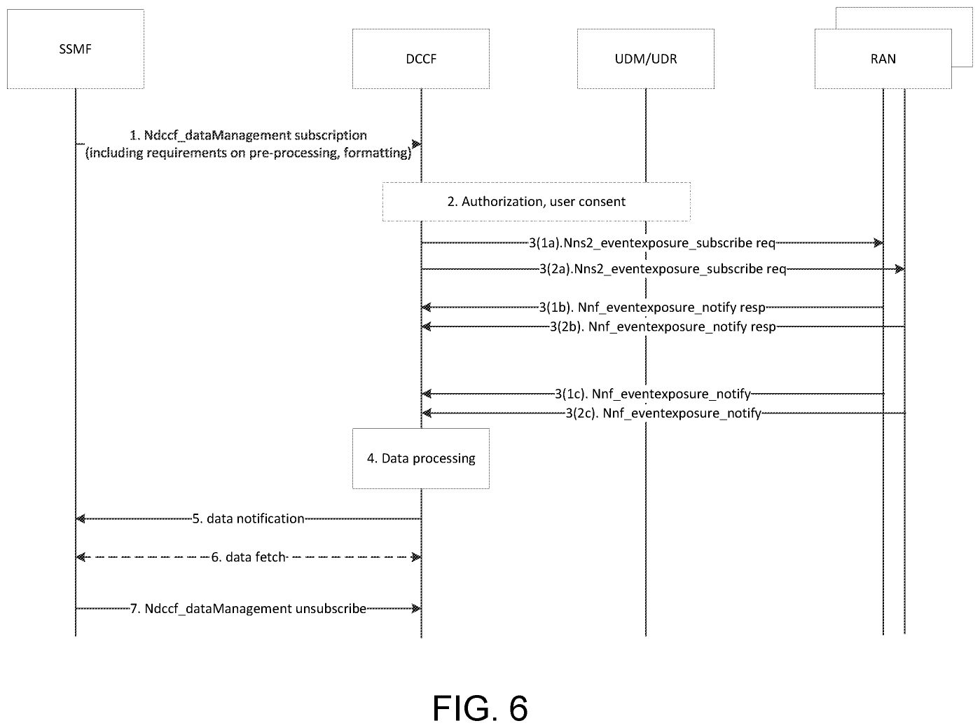

Referring to FIG. 6, there is shown a flow for sensing data collection by DCCF.

1) The SSMF may use an NRF to perform NF discovery and selection to find a DCCF that can coordinate data collection. SSMF sends a subscription request for sensing data collection to DCCF with the required pre-processing and formatting. This message shall include the sensing analytics ID, sensing data filter, [ADRF endpoint], [RAN identifier]. If the data is related to a certain event defined in Table 2, the event ID needs to be included. If a NWDAF subscribes for data directly with a RAN, or a RAN has stored data in an ADRF, the NWDAF or ADRF may register the data collection profile (NWDAF ID or ADRF ID specifies the ADRF or NWDAF which registers the data collection profile) with the DCCF.

2) Optionally, DCCF may check with UDM or UDR about whether this sensing data collection is allowed or the user's consent if any UE is involved

3) DCCF checks whether the required data is already being collected corresponding to the sensing analytics ID. If not, DCCF sends a data subscription request to RAN with the requested sensing data filter as described in Table 2 with DCCF indicated as Notification Target Address. RAN sends a data subscription response to indicate the results of the subscription. When the data is collected, RAN can notify DCCF and send the sensing data to DCCF. In these message exchanges, sensing data is needed together with the metadata to label the data. When the sensing data is sent to DCCF, MFAF can be leveraged for data delivery.

4) DCCF may perform further data processing and formatting based on the requirements sent by SSMF in step 1.

5) DCCF notifies SSMF and any additional notification end point(s) included in step 1 that data is ready and sends the sensing directly to SSMF with its metadata.

6) Alternatively, SSMF can fetch sensing data in a separate message. It can also get the sensing data through MFAF.

7) SSMF sends a Ndccf_dataManagement_unsubscribe request to stop the data collection.

### NWDAF Based Sensing Data Collection:

NWDAF can alternatively request sensing data through AMF via N2 or the SBI exposed by RAN for data management.

Sensing Analytics Retrieval from NWDAF:

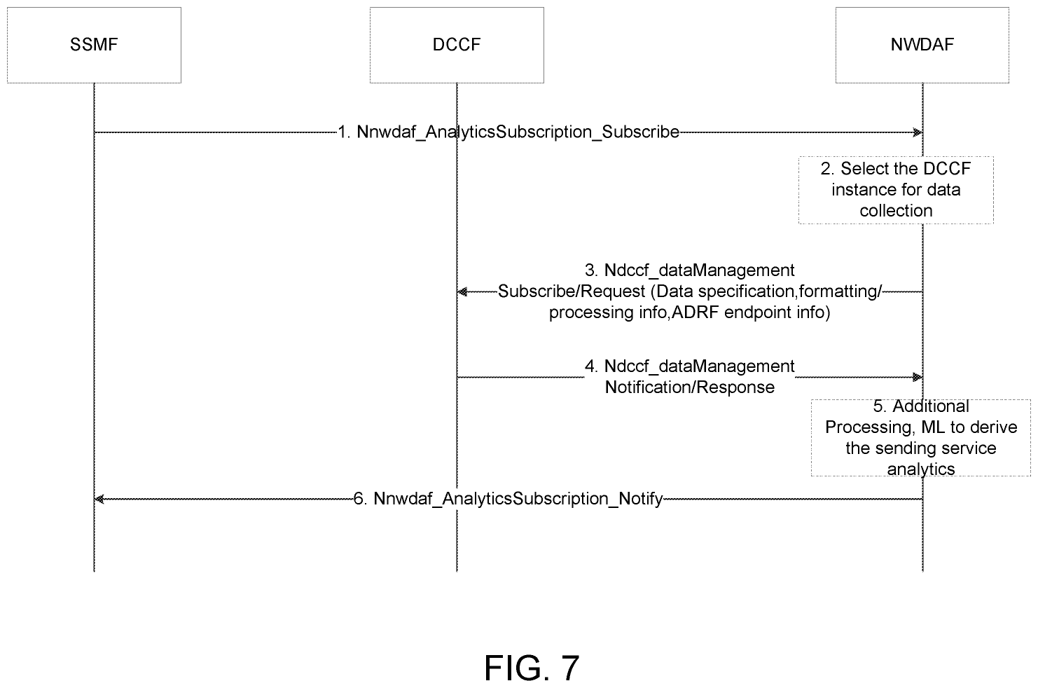

SSMF can request sensing data analytics from NWDAF, which can collect sensing data directly, through DCCF or ADRF as a background process. NWDAF can also register the supported analytics with DCCF or NRF as part of the NF profile for SSMF to find the right NWDAF instance based on sensing data filters. The message flow is shown in FIG. 7.

Referring to FIG. 7, the is shown sensing data analytics retrieval from NWDAF via DCCF.

1) The SSMF discovers and selects an NWDAF via the NRF based on the Analytics ID, supported services, NWDAF capabilities, NWDAF serving area information.

2) SSMF sends an Analytics request/subscribe to NWDAF with the criteria of the sensing data or analytics based on the sensing data analytics ID, event ID and the parameters defined in Table 2, Target of analytics reporting, Analytics Filter information, reporting endpoint (e.g., AF).

The term “Analytics Filter information” in the context of “Statistics or predictions on UE (User Equipment) mobility” refers to the criteria or conditions set to refine the analysis of user equipment behavior within a telecommunications network. When “visited AOI(s)” (Area of Interest) is specified in the Analytics Filter, the focus narrows down specifically to statistics related to UE mobility within those predefined geographic or network areas.

3) If DCCF is used for data collection and coordination in the network, the NWDAF selects a DCCF instance based on the DCCF Serving Area information.

4) The NWDAF sends a dataManagement subscription request to the DCCF with the required pre-processing and formatting. This message shall include the sensing analytics ID, sensing data filter, [ADRF endpoint], [RAN identifier], [notification endpoint(s)].

5) DCCF notifies NWDAF and any additional notification endpoint(s) included in step 3 via dataManagement notification message with the requested sending data.

6) NWDAF derives the requested sensing service analytics based on the data received from DCCF.

7) NWDAF sends Nnwdaf_AnalyticsSubscription_Notify or response SSMF with the requested sensing data analytics.

In some embodiment, the SSMF send a request to DCCF with the criteria of the sensing data or analytics based on the sensing data analytics ID, event ID and the parameters defined in Table 2, based on this trigger the DCCF may subscribe with the NWDAF to receive Sensing Service analytics.

In one or more embodiments, a sensing service coordination system may facilitate that the sensing data analytics ID defined in additional to current analytics IDs to identify sensing data and related analytics

In one or more embodiments, a sensing service coordination system may facilitate that the sensing event IDs defined to capture the events related to sensing which could trigger other sensing service process

In one or more embodiments, a sensing service coordination system may facilitate that the sensing data parameters that could be used as a data filter or metadata to collect, retrieve, label and store the sensing data

In one or more embodiments, a sensing service coordination system may facilitate that the above identified information can be exchanged among RAN, SSMF, DCCF, NWDAF, ADRF.

In one or more embodiments, a sensing service coordination system may facilitate that the sensing data analytics ID, event IDs and sensing data metadata that can be used to:
Store and label the sensing data between RAN and ADRF directly.
SSMF may instruct RAN about how to store the sensing data and subscribe to sensing event change/update.
SSMF may request to collect sensing data via DCCF or NWDAF.
SSMF may retrieve sensing data and analytics from NWDAF.

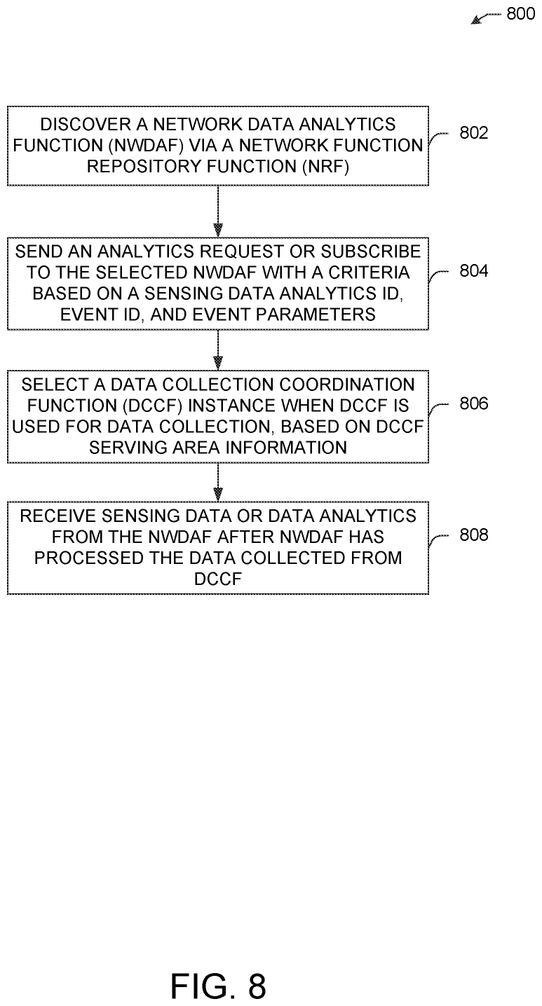

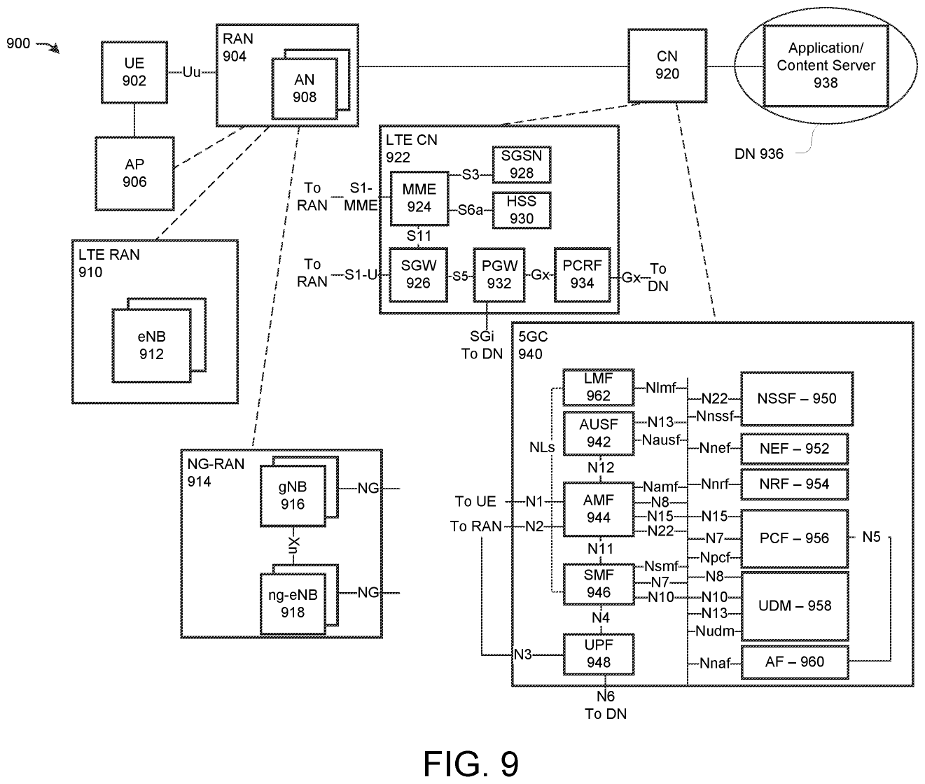

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process is depicted in FIG. 8.

For example, the process may include, at 802, discovering a Network Data Analytics Function (NWDAF) via a Network Function Repository Function (NRF).

The process further includes, at 804, sending an Analytics request or subscribing to the selected NWDAF with a criteria based on a sensing data analytics ID, event ID, and event parameters.

The process further includes, at 806, selecting a Data Collection Coordination Function (DCCF) instance when DCCF is used for data collection, based on DCCF Serving Area Information.

The process further includes, at 808, receiving sensing data or data analytics from the NWDAF after NWDAF has processed the data collected from DCCF.

The device may base the discovery and selection of the NWDAF on factors such as an Analytics ID for sensing service, supported services, NWDAF capabilities, or NWDAF serving area information. The device may also determine the NWDAF based on supported analytics registered with DCCF or NRF. Additionally, the device may include an Event ID comprising one of Sensing Target Status Update, Sensing Target Mobility, Sensing Configuration Update, Sensing Capability Update, or Sensing Quality of Service Update. The device may specify a reporting endpoint for the analytics, which could be an Application Function (AF). Moreover, the device may send a Nnwdaf_AnalyticsSubsription_Subscribe message to the NWDAF and may be configured to receive a Nnwdaf_AnalyticsSubscription_Notify comprising the sensing data or generated data analytics. The device may send a request to the DCCF with a criteria of the sensing data or analytics based on the sensing data analytics ID, event ID, and event parameters. The device may also trigger the SSMF or other sensing data and data analytics consumer to subscribe with the NWDAF to receive Sensing Service analytics. Lastly, the device may use interfaces between SSMF and DCCF, SSMF and NWDAF, SSMF and ADRF that are NS5, NS6, and NS7, respectively.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is understood that the above descriptions are for purposes of illustration and are not meant to be limiting.

FIGs. Error! Reference source not found.—Error! Reference source not found. illustrate various systems, devices, and components that may implement aspects of disclosed embodiments.

FIG. 9 illustrates an example network architecture 900 according to various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 includes a UE 902, which is any mobile or non-mobile computing device designed to communicate with a RAN 904 via an over-the-air connection. The UE 902 is communicatively coupled with the RAN 904 by a Uu interface, which may be applicable to both LTE and NR systems. Examples of the UE 902 include, but are not limited to, a smartphone, tablet computer, wearable computer, desktop computer, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, and/or the like. The network 900 may include a plurality of UEs 902 coupled directly with one another via a D2D, ProSe, PC5, and/or sidelink (SL) interface. These UEs 902 may be M2M/D2D/MTC/IoT devices and/or vehicular systems that communicate using physical sidelink channels such as, but not limited to, PSBCH, PSDCH, PSSCH, PSCCH, PSFCH, etc. The UE 902 may perform blind decoding attempts of SL channels/links according to the various embodiments herein.

In some embodiments, the UE 902 may additionally communicate with an AP 906 via an over-the-air (OTA) connection. The AP 906 manages a WLAN connection, which may serve to offload some/all network traffic from the RAN 904. The connection between the UE 902 and the AP 906 may be consistent with any IEEE 802.11 protocol. Additionally, the UE 902, RAN 904, and AP 906 may utilize cellular-WLAN aggregation/integration (e.g., LWA/LWIP). Cellular-WLAN aggregation may involve the UE 902 being configured by the RAN 904 to utilize both cellular radio resources and WLAN resources.

The RAN 904 includes one or more access network nodes (ANs) 908. The ANs 908 terminate air-interface(s) for the UE 902 by providing access stratum protocols including RRC, PDCP, RLC, MAC, and PHY/L1 protocols. In this manner, the AN 908 enables data/voice connectivity between CN 920 and the UE 902. The ANs 908 may be a macrocell base station or a low power base station for providing femtocells, picocells or other like cells having smaller coverage areas, smaller user capacity, or higher bandwidth compared to macrocells; or some combination thereof. In these implementations, an AN 908 be referred to as a BS, gNB, RAN node, eNB, ng-eNB, NodeB, RSU, TRxP, etc.

One example implementation is a “CU/DU split” architecture where the ANs 908 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like) (see e.g., 3GPP TS 38.401 v16.1.0 (2020-03)). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 908 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The plurality of ANs may be coupled with one another via an X2 interface (if the RAN 904 is an LTE RAN or Evolved Universal Terrestrial Radio Access Network (E-UTRAN) 910) or an Xn interface (if the RAN 904 is a NG-RAN 914). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs 908 of the RAN 904. For example, the UE 902 and RAN 904 may use carrier aggregation to allow the UE 902 to connect with a plurality of component carriers, each corresponding to a Pcell or Scell. In dual connectivity scenarios, a first AN 908 may be a master node that provides an MCG and a second AN 908 may be secondary node that provides an SCG. The first/second ANs 908 may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a roadside unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an E-UTRAN 910 with one or more eNBs 912. The an E-UTRAN 910 provides an LTE air interface (Uu) with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an next generation (NG)-RAN 914 with one or more gNB 916 and/or on or more ng-eNB 918. The gNB 916 connects with 5G-enabled UEs 902 using a 5G NR interface. The gNB 916 connects with a 5GC 940 through an NG interface, which includes an N2 interface or an N3 interface. The ng-eNB 918 also connects with the 5GC 940 through an NG interface, but may connect with a UE 902 via the Uu interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

The 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (e.g., PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements and/or network functions (NFs) to provide various functions to support data and telecommunications services to customers/subscribers (e.g., UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

The CN 920 may be an LTE CN 922 (also referred to as an Evolved Packet Core (EPC) 922). The EPC 922 may include MME 924, SGW 926, SGSN 928, HSS 930, PGW 932, and PCRF 934 coupled with one another over interfaces (or “reference points”) as shown. The NFs in the EPC 922 are briefly introduced as follows.

The MME 924 implements mobility management functions to track a current location of the UE 902 to facilitate paging, bearer activation/deactivation, handovers, gateway selection, authentication, etc.

The SGW 926 terminates an S1 interface toward the RAN 910 and routes data packets between the RAN 910 and the EPC 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 tracks a location of the UE 902 and performs security functions and access control. The SGSN 928 also performs inter-EPC node signaling for mobility between different RAT networks; PDN and S-GW selection as specified by MME 924; MME 924 selection for handovers; etc. The S3 reference point between the MME 924 and the SGSN 928 enable user and bearer information exchange for inter-3GPP access network mobility in idle/active states.

The HSS 930 includes a database for network users, including subscription-related information to support the network entities' handling of communication sessions. The HSS 930 can provide support for routing/roaming, authentication, authorization, naming/addressing resolution, location dependencies, etc. An Soa reference point between the HSS 930 and the MME 924 may enable transfer of subscription and authentication data for authenticating/authorizing user access to the EPC 920.

The PGW 932 may terminate an SGi interface toward a data network (DN) 936 that may include an application (app)/content server 938. The PGW 932 routes data packets between the EPC 922 and the data network 936. The PGW 932 is communicatively coupled with the SGW 926 by an S5 reference point to facilitate user plane tunneling and tunnel management. The PGW 932 may further include a node for policy enforcement and charging data collection (e.g., PCEF). Additionally, the SGi reference point may communicatively couple the PGW 932 with the same or different data network 936. The PGW 932 may be communicatively coupled with a PCRF 934 via a Gx reference point.

The PCRF 934 is the policy and charging control element of the EPC 922. The PCRF 934 is communicatively coupled to the app/content server 938 to determine appropriate QoS and charging parameters for service flows. The PCRF 932 also provisions associated rules into a PCEF (via Gx reference point) with appropriate TFT and QCI.

The CN 920 may be a 5GC 940 including an AUSF 942, AMF 944, SMF 946, UPF 948, NSSF 950, NEF 952, NRF 954, PCF 956, UDM 958, and AF 960 coupled with one another over various interfaces as shown. The NFs in the 5GC 940 are briefly introduced as follows.

The AUSF 942 stores data for authentication of UE 902 and handle authentication-related functionality. The AUSF 942 may facilitate a common authentication framework for various access types.

The AMF 944 allows other functions of the 5GC 940 to communicate with the UE 902 and the RAN 904 and to subscribe to notifications about mobility events with respect to the UE 902. The AMF 944 is also responsible for registration management (e.g., for registering UE 902), connection management, reachability management, mobility management, lawful interception of AMF-related events, and access authentication and authorization. The AMF 944 provides transport for SM messages between the UE 902 and the SMF 946, and acts as a transparent proxy for routing SM messages. AMF 944 also provides transport for SMS messages between UE 902 and an SMSF. AMF 944 interacts with the AUSF 942 and the UE 902 to perform various security anchor and context management functions. Furthermore, AMF 944 is a termination point of a RAN-CP interface, which includes the N2 reference point between the RAN 904 and the AMF 944. The AMF 944 is also a termination point of NAS (N1) signaling, and performs NAS ciphering and integrity protection.

AMF 944 also supports NAS signaling with the UE 902 over an N3IWF interface. The N3IWF provides access to untrusted entities. N3IWF may be a termination point for the N2 interface between the (R)AN 904 and the AMF 944 for the control plane, and may be a termination point for the N3 reference point between the (R)AN 914 and the 948 for the user plane. As such, the AMF 944 handles N2 signalling from the SMF 946 and the AMF 944 for PDU sessions and QoS, encapsulate/de-encapsulate packets for IPSec and N3 tunnelling, marks N3 user-plane packets in the uplink, and enforces QoS corresponding to N3 packet marking taking into account QoS requirements associated with such marking received over N2. N3IWF may also relay UL and DL control-plane NAS signalling between the UE 902 and AMF 944 via an N1 reference point between the UE 902 and the AMF 944, and relay uplink and downlink user-plane packets between the UE 902 and UPF 948. The N3IWF also provides mechanisms for IPsec tunnel establishment with the UE 902. The AMF 944 may exhibit an Namf service-based interface, and may be a termination point for an N14 reference point between two AMFs 944 and an N17 reference point between the AMF 944 and a 5G-EIR (not shown by FIG. 9).

The SMF 946 is responsible for SM (e.g., session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM refers to management of a PDU session, and a PDU session or “session” refers to a PDU connectivity service that provides or enables the exchange of PDUs between the UE 902 and the DN 936.

The UPF 948 acts as an anchor point for intra-RAT and inter-RAT mobility, an external PDU session point of interconnect to data network 936, and a branching point to support multi-homed PDU session. The UPF 948 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs uplink traffic verification (e.g., SDF-to-QoS flow mapping), transport level packet marking in the uplink and downlink, and performs downlink packet buffering and downlink data notification triggering. UPF 948 may include an uplink classifier to support routing traffic flows to a data network.

The NSSF 950 selects a set of network slice instances serving the UE 902. The NSSF 950 also determines allowed NSSAI and the mapping to the subscribed S-NSSAIs, if needed. The NSSF 950 also determines an AMF set to be used to serve the UE 902, or a list of candidate AMFs 944 based on a suitable configuration and possibly by querying the NRF 954. The selection of a set of network slice instances for the UE 902 may be triggered by the AMF 944 with which the UE 902 is registered by interacting with the NSSF 950; this may lead to a change of AMF 944. The NSSF 950 interacts with the AMF 944 via an N22 reference point; and may communicate with another NSSF in a visited network via an N31 reference point (not shown).

The NEF 952 securely exposes services and capabilities provided by 3GPP NFs for third party, internal exposure/re-exposure, AFs 960, edge computing or fog computing systems (e.g., edge compute node, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics.

The NRF 954 supports service discovery functions, receives NF discovery requests from NF instances, and provides information of the discovered NF instances to the requesting NF instances. NRF 954 also maintains information of available NF instances and their supported services. The NRF 954 also supports service discovery functions, wherein the NRF 954 receives NF Discovery Request from NF instance or an SCP (not shown), and provides information of the discovered NF instances to the NF instance or SCP.

The PCF 956 provides policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 handles subscription-related information to support the network entities' handling of communication sessions, and stores subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

AF 960 provides application influence on traffic routing, provide access to NEF 952, and interact with the policy framework for policy control. The AF 960 may influence UPF 948 (re)selection and traffic routing. Based on operator deployment, when AF 960 is considered to be a trusted entity, the network operator may permit AF 960 to interact directly with relevant NFs. Additionally, the AF 960 may be used for edge computing implementations,

The 5GC 940 may enable edge computing by selecting operator/3rd party services to be geographically close to a point that the UE 902 is attached to the network. This may reduce latency and load on the network. In edge computing implementations, the 5GC 940 may select a UPF 948 close to the UE 902 and execute traffic steering from the UPF 948 to DN 936 via the N6 interface. This may be based on the UE subscription data, UE location, and information provided by the AF 960, which allows the AF 960 to influence UPF (re)selection and traffic routing.

The data network (DN) 936 may represent various network operator services, Internet access, or third party services that may be provided by one or more servers including, for example, application (app)/content server 938. The DN 936 may be an operator external public, a private PDN, or an intra-operator packet data network, for example, for provision of IMS services. In this embodiment, the app server 938 can be coupled to an IMS via an S-CSCF or the I-CSCF. In some implementations, the DN 936 may represent one or more local area DNs (LADNs), which are DNs 936 (or DN names (DNNs)) that is/are accessible by a UE 902 in one or more specific areas. Outside of these specific areas, the UE 902 is not able to access the LADN/DN 936.

Additionally or alternatively, the DN 936 may be an Edge DN 936, which is a (local) Data Network that supports the architecture for enabling edge applications. In these embodiments, the app server 938 may represent the physical hardware systems/devices providing app server functionality and/or the application software resident in the cloud or at an edge compute node that performs server function(s). In some embodiments, the app/content server 938 provides an edge hosting environment that provides support required for Edge Application Server's execution.

In some embodiments, the 5GS can use one or more edge compute nodes to provide an interface and offload processing of wireless communication traffic. In these embodiments, the edge compute nodes may be included in, or co-located with one or more RAN 910, 914. For example, the edge compute nodes can provide a connection between the RAN 914 and UPF 948 in the 5GC 940. The edge compute nodes can use one or more NFV instances instantiated on virtualization infrastructure within the edge compute nodes to process wireless connections to and from the RAN 914 and UPF 948.

The interfaces of the 5GC 940 include reference points and service-based interfaces. The reference points include: N1 (between the UE 902 and the AMF 944), N2 (between RAN 914 and AMF 944), N3 (between RAN 914 and UPF 948), N4 (between the SMF 946 and UPF 948), N5 (between PCF 956 and AF 960), N6 (between UPF 948 and DN 936), N7 (between SMF 946 and PCF 956), N8 (between UDM 958 and AMF 944), N9 (between two UPFs 948), N10 (between the UDM 958 and the SMF 946), N11 (between the AMF 944 and the SMF 946), N12 (between AUSF 942 and AMF 944), N13 (between AUSF 942 and UDM 958), N14 (between two AMFs 944; not shown), N15 (between PCF 956 and AMF 944 in case of a non-roaming scenario, or between the PCF 956 in a visited network and AMF 944 in case of a roaming scenario), N16 (between two SMFs 946; not shown), and N22 (between AMF 944 and NSSF 950). Other reference point representations not shown in FIG. 9 can also be used. The service-based representation of FIG. 9 represents NFs within the control plane that enable other authorized NFs to access their services. The service-based interfaces (SBIs) include: Namf (SBI exhibited by AMF 944), Nsmf (SBI exhibited by SMF 946), Nnef (SBI exhibited by NEF 952), Npcf (SBI exhibited by PCF 956), Nudm (SBI exhibited by the UDM 958), Naf (SBI exhibited by AF 960), Nnrf (SBI exhibited by NRF 954), Nnssf (SBI exhibited by NSSF 950), Nausf (SBI exhibited by AUSF 942).

Other service-based interfaces (e.g., Nudr, N5g-eir, and Nudsf) not shown in FIG. 9 can also be used. In some embodiments, the NEF 952 can provide an interface to edge compute nodes 936x, which can be used to process wireless connections with the RAN 914. In some implementations, the system 900 may include an SMSF, which is responsible for SMS subscription checking and verification, and relaying SM messages to/from the UE 902 to/from other entities, such as an SMS-GMSC/IWMSC/SMS-router. The SMS may also interact with AMF 944 and UDM 958 for a notification procedure that the UE 902 is available for SMS transfer (e.g., set a UE not reachable flag, and notifying UDM 958 when UE 902 is available for SMS).

The 5GS may also include an SCP (or individual instances of the SCP) that supports indirect communication (see e.g., 3GPP TS 23.501 section 7.1.1); delegated discovery (see e.g., 3GPP TS 23.501 section 7.1.1); message forwarding and routing to destination NF/NF service(s), communication security (e.g., authorization of the NF Service Consumer to access the NF Service Producer API) (see e.g., 3GPP TS 33.501), load balancing, monitoring, overload control, etc.; and discovery and selection functionality for UDM(s), AUSF(s), UDR(s), PCF(s) with access to subscription data stored in the UDR based on UE's SUPI, SUCI or GPSI (see e.g., 3GPP TS 23.501 section 6.3). Load balancing, monitoring, overload control functionality provided by the SCP may be implementation specific. The SCP may be deployed in a distributed manner. More than one SCP can be present in the communication path between various NF Services. The SCP, although not an NF instance, can also be deployed distributed, redundant, and scalable.

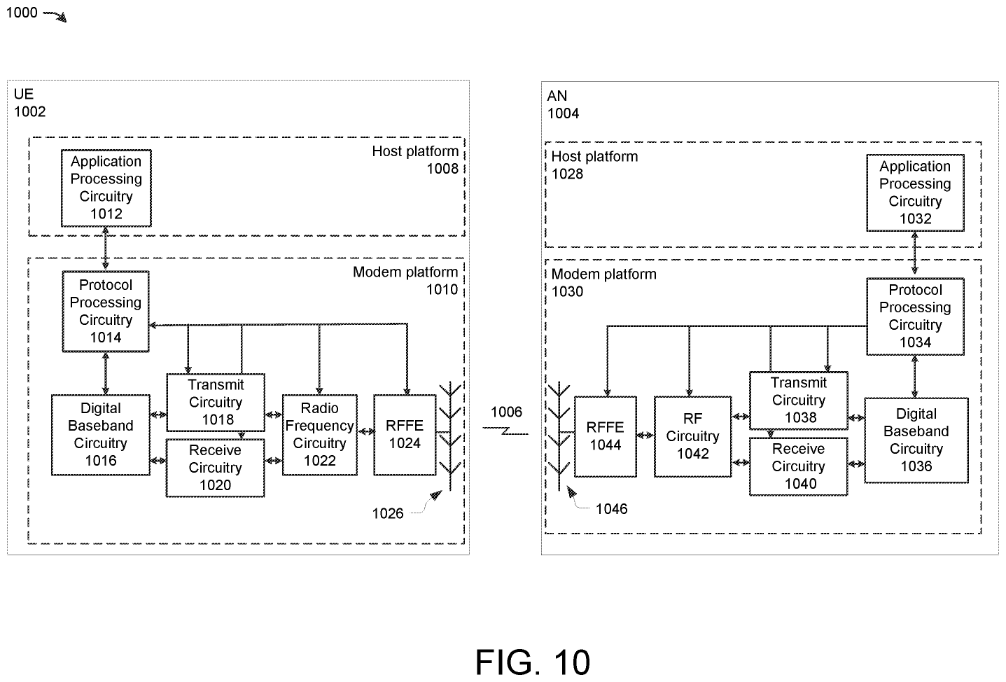

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described with respect to FIG. 9.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHZ frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ acknowledgement (ACK) functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE 1002 reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE 1002 transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

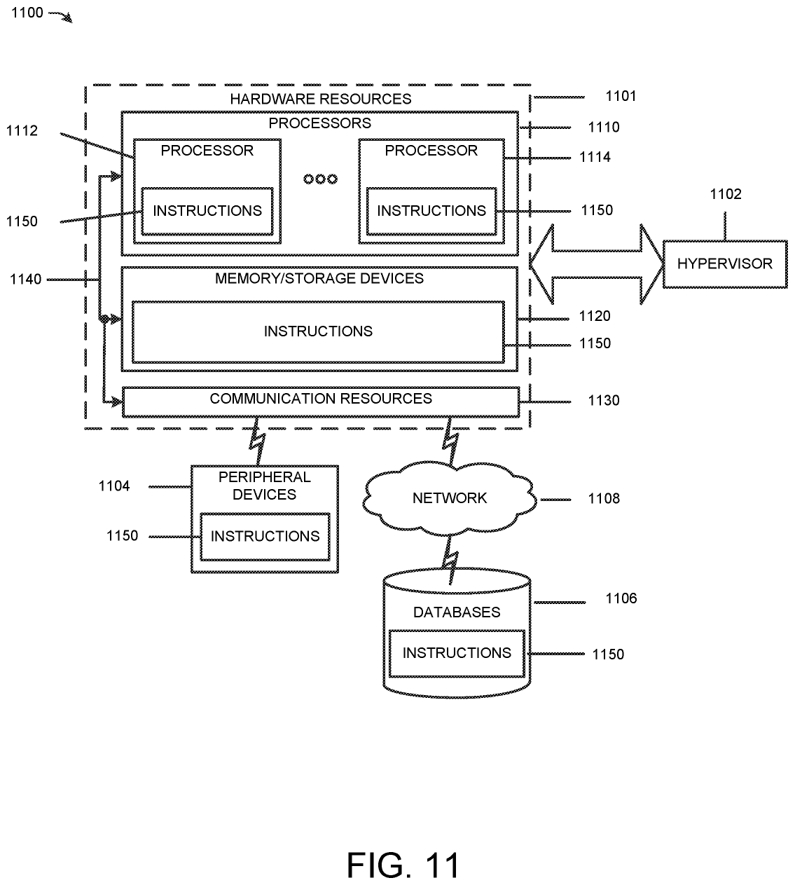

FIG. 11 illustrates components of a computing device 1100 according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1101 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1101.

The processors 1110 include, for example, processor 1112 and processor 1114. The processors 1110 include circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. The processors 1110 may be, for example, a central processing unit (CPU), reduced instruction set computing (RISC) processors, Acorn RISC Machine (ARM) processors, complex instruction set computing (CISC) processors, graphics processing units (GPUs), one or more Digital Signal Processors (DSPs) such as a baseband processor, Application-Specific Integrated Circuits (ASICs), an Field-Programmable Gate Array (FPGA), a radio-frequency integrated circuit (RFIC), one or more microprocessors or controllers, another processor (including those discussed herein), or any suitable combination thereof. In some implementations, the processor circuitry 1110 may include one or more hardware accelerators, which may be microprocessors, programmable processing devices (e.g., FPGA, complex programmable logic devices (CPLDs), etc.), or the like.

The memory/storage devices 1120 may include main memory, disk storage, or any suitable combination thereof. The memory/storage devices 1120 may include, but are not limited to, any type of volatile, non-volatile, or semi-volatile memory such as random access memory (RAM), dynamic RAM (DRAM), static RAM (SRAM), synchronous DRAM (SDRAM), erasable programmable read-only memory (EPROM), electrically erasable programmable read-only memory (EEPROM), Flash memory, solid-state storage, phase change RAM (PRAM), resistive memory such as magnetoresistive random access memory (MRAM), etc., and may incorporate three-dimensional (3D) cross-point (XPOINT) memories from Intel® and Micron®. The memory/storage devices 1120 may also comprise persistent storage devices, which may be temporal and/or persistent storage of any type, including, but not limited to, non-volatile memory, optical, magnetic, and/or solid state mass storage, and so forth.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, Ethernet, Ethernet over GRE Tunnels, Ethernet over Multiprotocol Label Switching (MPLS), Ethernet over USB, Controller Area Network (CAN), Local Interconnect Network (LIN), DeviceNet, ControlNet, Data Highway+, PROFIBUS, or PROFINET, among many others), cellular communication components, NFC components, Bluetooth® (or Bluetooth® Low Energy) components, WiFi® components, and other communication components. Network connectivity may be provided to/from the computing device 1100 via the communication resources 1130 using a physical connection, which may be electrical (e.g., a “copper interconnect”) or optical. The physical connection also includes suitable input connectors (e.g., ports, receptacles, sockets, etc.) and output connectors (e.g., plugs, pins, etc.). The communication resources 1130 may include one or more dedicated processors and/or FPGAs to communicate using one or more of the aforementioned network interface protocols.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1101 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

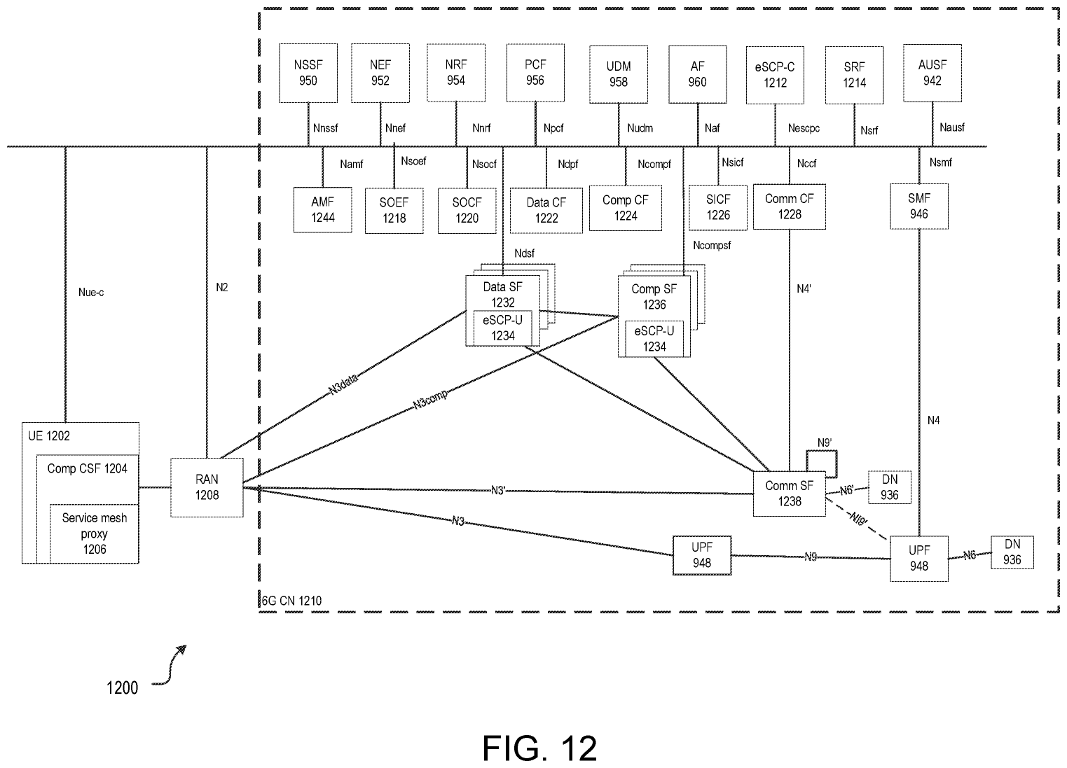

FIG. 12 illustrates a network 1200 in accordance with various embodiments. The network 1200 may operate in a matter consistent with 3GPP technical specifications or technical reports for 6G systems. In some embodiments, the network 1200 may operate concurrently with network 900. For example, in some embodiments, the network 1200 may share one or more frequency or bandwidth resources with network 900. As one specific example, a UE (e.g., UE 1202) may be configured to operate in both network 1200 and network 900. Such configuration may be based on a UE including circuitry configured for communication with frequency and bandwidth resources of both networks 900 and 1200. In general, several elements of network 1200 may share one or more characteristics with elements of network 900. For the sake of brevity and clarity, such elements may not be repeated in the description of network 1200.

The network 1200 may include a UE 1202, which may include any mobile or non-mobile computing device designed to communicate with a RAN 1208 via an over-the-air connection. The UE 1202 may be similar to, for example, UE 902. The UE 1202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 12, in some embodiments the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 12, the UE 1202 may be communicatively coupled with an AP such as AP 906 as described with respect to FIG. 9. Additionally, although not specifically shown in FIG. 12, in some embodiments the RAN 1208 may include one or more ANss such as AN 908 as described with respect to FIG. 9. The RAN 1208 and/or the AN of the RAN 1208 may be referred to as a base station (BS), a RAN node, or using some other term or name.

The UE 1202 and the RAN 1208 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1208 may allow for communication between the UE 1202 and a 6G core network (CN) 1210. Specifically, the RAN 1208 may facilitate the transmission and reception of data between the UE 1202 and the 6G CN 1210. The 6G CN 1210 may include various functions such as NSSF 950, NEF 952, NRF 954, PCF 956, UDM 958, AF 960, SMF 946, and AUSF 942. The 6G CN 1210 may additional include UPF 948 and DN 936 as shown in FIG. 12.

Additionally, the RAN 1208 may include various additional functions that are in addition to, or alternative to, functions of a legacy cellular network such as a 4G or 5G network. Two such functions may include a Compute Control Function (Comp CF) 1224 and a Compute Service Function (Comp SF) 1236. The Comp CF 1224 and the Comp SF 1236 may be parts or functions of the Computing Service Plane. Comp CF 1224 may be a control plane function that provides functionalities such as management of the Comp SF 1236, computing task context generation and management (e.g., create, read, modify, delete), interaction with the underlaying computing infrastructure for computing resource management, etc., Comp SF 1236 may be a user plane function that serves as the gateway to interface computing service users (such as UE 1202) and computing nodes behind a Comp SF instance. Some functionalities of the Comp SF 1236 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1236 instance may serve as the user plane gateway for a cluster of computing nodes. A Comp CF 1224 instance may control one or more Comp SF 1236 instances.

Two other such functions may include a Communication Control Function (Comm CF) 1228 and a Communication Service Function (Comm SF) 1238, which may be parts of the Communication Service Plane. The Comm CF 1228 may be the control plane function for managing the Comm SF 1238, communication sessions creation/configuration/releasing, and managing communication session context. The Comm SF 1238 may be a user plane function for data transport. Comm CF 1228 and Comm SF 1238 may be considered as upgrades of SMF 946 and UPF 948, which were described with respect to a 5G system in FIG. 9. The upgrades provided by the Comm CF 1228 and the Comm SF 1238 may enable service-aware transport. For legacy (e.g., 4G or 5G) data transport, SMF 946 and UPF 948 may still be used.

Two other such functions may include a Data Control Function (Data CF) 1222 and Data Service Function (Data SF) 1232 may be parts of the Data Service Plane. Data CF 1222 may be a control plane function and provides functionalities such as Data SF 1232 management, Data service creation/configuration/releasing, Data service context management, etc. Data SF 1232 may be a user plane function and serve as the gateway between data service users (such as UE 1202 and the various functions of the 6G CN 1210) and data service endpoints behind the gateway. Specific functionalities may include: parse data service user data and forward to corresponding data service endpoints, generate charging data, report data service status.

Another such function may be the Service Orchestration and Chaining Function (SOCF) 1220, which may discover, orchestrate and chain up communication/computing/data services provided by functions in the network. Upon receiving service requests from users, SOCF 1220 may interact with one or more of Comp CF 1224, Comm CF 1228, and Data CF 1222 to identify Comp SF 1236, Comm SF 1238, and Data SF 1232 instances, configure service resources, and generate the service chain, which could contain multiple Comp SF 1236, Comm SF 1238, and Data SF 1232 instances and their associated computing endpoints. Workload processing and data movement may then be conducted within the generated service chain. The SOCF 1220 may also responsible for maintaining, updating, and releasing a created service chain.

Another such function may be the service registration function (SRF) 1214, which may act as a registry for system services provided in the user plane such as services provided by service endpoints behind Comp SF 1236 and Data SF 1232 gateways and services provided by the UE 1202. The SRF 1214 may be considered a counterpart of NRF 954, which may act as the registry for network functions.

Other such functions may include an evolved service communication proxy (eSCP) and service infrastructure control function (SICF) 1226, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1212 and eSCP-U 1234, for control plane service communication proxy and user plane service communication proxy, respectively. The SICF 1226 may control and configure eCSP instances in terms of service traffic routing policies, access rules, load balancing configurations, performance monitoring, etc.

Another such function is the AMF 1244. The AMF 1244 may be similar to 944, but with additional functionality. Specifically, the AMF 1244 may include potential functional repartition, such as move the message forwarding functionality from the AMF 1244 to the RAN 1208.

Another such function is the service orchestration exposure function (SOEF) 1218. The SOEF may be configured to expose service orchestration and chaining services to external users such as applications.

The UE 1202 may include an additional function that is referred to as a computing client service function (comp CSF) 1204. The comp CSF 1204 may have both the control plane functionalities and user plane functionalities, and may interact with corresponding network side functions such as SOCF 1220, Comp CF 1224, Comp SF 1236, Data CF 1222, and/or Data SF 1232 for service discovery, request/response, compute task workload exchange, etc. The Comp CSF 1204 may also work with network side functions to decide on whether a computing task should be run on the UE 1202, the RAN 1208, and/or an element of the 6G CN 1210.

The UE 1202 and/or the Comp CSF 1204 may include a service mesh proxy 1206. The service mesh proxy 1206 may act as a proxy for service-to-service communication in the user plane. Capabilities of the service mesh proxy 1206 may include one or more of addressing, security, load balancing, etc.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Additional examples of the presently described embodiments include the following, non-limiting implementations. Each of the following non-limiting examples may stand on its own or may be combined in any permutation or combination with any one or more of the other examples provided below or throughout the present disclosure.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below.

The following examples pertain to further embodiments.

Example 1 may include an apparatus comprising discover a Network Data Analytics Function (NWDAF) via a Network Function Repository Function (NRF); send an Analytics request or subscribe to the selected NWDAF with a criteria based on a sensing data analytics ID, event ID, and event parameters; select a Data Collection Coordination Function (DCCF) instance when DCCF may be used for data collection, based on DCCF Serving Area Information; and receive sensing data or data analytics from the NWDAF after NWDAF has processed the data collected from DCCF.

Example 2 may include the apparatus of example 1 and/or some other example herein, wherein the discovery and selection of the NWDAF may be based on an Analytics ID for sensing service for sensing service, supported services, NWDAF capabilities, or NWDAF serving area information.

Example 3 may include the apparatus of example 1 and/or some other example herein, wherein the processing circuitry may be further configured to determine the NWDAF based on supported analytics registered with DCCF or NRF.

Example 4 may include the apparatus of example 1 and/or some other example herein, wherein the Event ID comprises one of Sensing Target Status Update, Sensing Target Mobility, Sensing Configuration Update, Sensing Capability Update, or Sensing Quality of Service Update.

Example 5 may include the apparatus of example 1 and/or some other example herein, wherein the processing circuitry may be further configured to specify a reporting endpoint for the analytics, such as an Application Function (AF).

Example 6 may include the apparatus of example 1 and/or some other example herein, wherein the processing circuitry may be further configured to send a Nnwdaf_AnalyticsSubsription_Subscribe message to the NWDAF.

Example 7 may include the apparatus of example 1 and/or some other example herein, wherein the processing circuitry may be further configured to receive a Nnwdaf_AnalyticsSubscription_Notify comprising the sensing data or generated data analytics.

Example 8 may include the apparatus of example 1 and/or some other example herein, wherein the processing circuitry may be further configured to send a request to the DCCF with a criteria of the sensing data or analytics based on the sensing data analytics ID, event ID, and event parameters.

Example 9 may include the apparatus of example 7 and/or some other example herein, wherein the processing circuitry may be further configured to trigger the DCCF to subscribe with the NWDAF to receive Sensing Service analytics.

Example 10 may include the apparatus of example 1 and/or some other example herein, wherein the interfaces between SSMF and DCCF, SSMF and NWDAF, SSMF and ADRF are NS5, NS6, and NS7, respectively.

Example 11 may include a computer-readable medium storing computer-executable instructions which when executed by one or more processors result in performing operations comprising: discovering a Network Data Analytics Function (NWDAF) via a Network Function Repository Function (NRF); sending an Analytics request or subscribe to the selected NWDAF with a criteria based on a sensing data analytics ID, event ID, and event parameters; selecting a Data Collection Coordination Function (DCCF) instance when DCCF may be used for data collection, based on DCCF Serving Area Information; and receiving sensing data or data analytics from the NWDAF after NWDAF has processed the data collected from DCCF.

Example 12 may include the computer-readable medium of example 11 and/or some other example herein, wherein the discovery and selection of the NWDAF may be based on an Analytics ID for sensing service for sensing service, supported services, NWDAF capabilities, or NWDAF serving area information.

Example 13 may include the computer-readable medium of example 11 and/or some other example herein, wherein the operations further comprise determining the NWDAF based on supported analytics registered with DCCF or NRF.

Example 14 may include the computer-readable medium of example 11 and/or some other example herein, wherein the Event ID comprises one of Sensing Target Status Update, Sensing Target Mobility, Sensing Configuration Update, Sensing Capability Update, or Sensing Quality of Service Update.

Example 15 may include the computer-readable medium of example 11 and/or some other example herein, wherein the operations further comprise specifying a reporting endpoint for the analytics, such as an Application Function (AF).

Example 16 may include the computer-readable medium of example 11 and/or some other example herein, wherein the operations further comprise sending a Nnwdaf_AnalyticsSubsription_Subscribe message to the NWDAF.

Example 17 may include the computer-readable medium of example 11 and/or some other herein, wherein the operations further comprise receiving a example Nnwdaf_AnalyticsSubscription_Notify comprising the sensing data or generated data analytics.

Example 18 may include the computer-readable medium of example 11 and/or some other example herein, wherein the operations further comprise sending a request to the DCCF with a criteria of the sensing data or analytics based on the sensing data analytics ID, event ID, and event parameters.

Example 19 may include the computer-readable medium of example 17 and/or some other example herein, wherein the operations further comprise triggering the DCCF to subscribe with the NWDAF to receive Sensing Service analytics.

Example 20 may include the computer-readable medium of example 11 and/or some other example herein, wherein the interfaces between SSMF and DCCF, SSMF and NWDAF, SSMF and ADRF are NS5, NS6, and NS7, respectively.

Example 21 may include a method comprising: discovering a Network Data Analytics Function (NWDAF) via a Network Function Repository Function (NRF); sending an Analytics request or subscribe to the selected NWDAF with a criteria based on a sensing data analytics ID, event ID, and event parameters; selecting a Data Collection Coordination Function (DCCF) instance when DCCF may be used for data collection, based on DCCF Serving Area Information; and receiving sensing data or data analytics from the NWDAF after NWDAF has processed the data collected from DCCF.

Example 22 may include the method of example 21 and/or some other example herein, wherein the discovery and selection of the NWDAF may be based on an Analytics ID for sensing service for sensing service, supported services, NWDAF capabilities, or NWDAF serving area information.

Example 23 may include the method of example 21 and/or some other example herein, further comprising determining the NWDAF based on supported analytics registered with DCCF or NRF.

Example 24 may include the method of example 21 and/or some other example herein, wherein the Event ID comprises one of Sensing Target Status Update, Sensing Target Mobility, Sensing Configuration Update, Sensing Capability Update, or Sensing Quality of Service Update.

Example 25 may include the method of example 21 and/or some other example herein, further comprising specifying a reporting endpoint for the analytics, such as an Application Function (AF).

Example 26 may include the method of example 21 and/or some other example herein, further comprising sending a Nnwdaf_AnalyticsSubsription_Subscribe message to the NWDAF.

Example 27 may include the method of example 21 and/or some other example herein, further comprising receiving a Nnwdaf_AnalyticsSubscription_Notify comprising the sensing data or generated data analytics.

Example 28 may include the method of example 21 and/or some other example herein, further comprising sending a request to the DCCF with a criteria of the sensing data or analytics based on the sensing data analytics ID, event ID, and event parameters.

Example 29 may include the method of example 27 and/or some other example herein, further comprising triggering the DCCF to subscribe with the NWDAF to receive Sensing Service analytics.

Example 30 may include the method of example 21 and/or some other example herein, wherein the interfaces between SSMF and DCCF, SSMF and NWDAF, SSMF and ADRF are NS5, NS6, and NS7, respectively.

Example 31 may include an apparatus comprising means for: discovering a Network Data Analytics Function (NWDAF) via a Network Function Repository Function (NRF); sending an Analytics request or subscribe to the selected NWDAF with a criteria based on a sensing data analytics ID, event ID, and event parameters; selecting a Data Collection Coordination Function (DCCF) instance when DCCF may be used for data collection, based on DCCF Serving Area Information; and receiving sensing data or data analytics from the NWDAF after NWDAF has processed the data collected from DCCF.

Example 32 may include the apparatus of example 31 and/or some other example herein, wherein the discovery and selection of the NWDAF may be based on an Analytics ID for sensing service for sensing service, supported services, NWDAF capabilities, or NWDAF serving area information.

Example 33 may include the apparatus of example 31 and/or some other example herein, further comprising determining the NWDAF based on supported analytics registered with DCCF or NRF.

Example 34 may include the apparatus of example 31 and/or some other example herein, wherein the Event ID comprises one of Sensing Target Status Update, Sensing Target Mobility, Sensing Configuration Update, Sensing Capability Update, or Sensing Quality of Service Update.

Example 35 may include the apparatus of example 31 and/or some other example herein, further comprising specifying a reporting endpoint for the analytics, such as an Application Function (AF).

Example 36 may include the apparatus of example 31 and/or some other example herein, further comprising sending a Nnwdaf_AnalyticsSubsription_Subscribe message to the NWDAF.

Example 37 may include the apparatus of example 31 and/or some other example herein, further comprising receiving a Nnwdaf_AnalyticsSubscription_Notify comprising the sensing data or generated data analytics.

Example 38 may include the apparatus of example 31 and/or some other example herein, further comprising sending a request to the DCCF with a criteria of the sensing data or analytics based on the sensing data analytics ID, event ID, and event parameters.

Example 39 may include the apparatus of example 37 and/or some other example herein, further comprising triggering the DCCF to subscribe with the NWDAF to receive Sensing Service analytics.

Example 40 may include the apparatus of example 31 and/or some other example herein, wherein the interfaces between SSMF and DCCF, SSMF and NWDAF, SSMF and ADRF are NS5, NS6, and NS7, respectively.

Example 41 may include an apparatus comprising means for performing any of the methods of examples 1-40.

Example 42 may include a network node comprising a communication interface and processing circuitry connected thereto and configured to perform the methods of examples 1-40.

Example 43 may include an apparatus comprising means to perform one or more elements of a method described in or related to any of examples 1-40, or any other method or process described herein.

Example 44 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example 45 may include an apparatus comprising logic, modules, or circuitry to perform one or more elements of a method described in or related to any of examples 1-40, or any other method or process described herein.

Example 46 may include a method, technique, or process as described in or related to any of examples 1-40, or portions or parts thereof.

Example 47 may include an apparatus comprising: one or more processors and one or more computer-readable media comprising instructions that, when executed by the one or more processors, cause the one or more processors to perform the method, techniques, or process as described in or related to any of examples 1-40, or portions thereof.

Example 48 may include a signal as described in or related to any of examples 1-40, or portions or parts thereof.

Example 49 may include a datagram, packet, frame, segment, protocol data unit (PDU), or message as described in or related to any of examples 1-40, or portions or parts thereof, or otherwise described in the present disclosure.

Example 50 may include a signal encoded with data as described in or related to any of examples 1-40, or portions or parts thereof, or otherwise described in the present disclosure.

Example 51 may include a signal encoded with a datagram, packet, frame, segment, protocol data unit (PDU), or message as described in or related to any of examples 1-40, or portions or parts thereof, or otherwise described in the present disclosure.

Example 52 may include an electromagnetic signal carrying computer-readable instructions, wherein execution of the computer-readable instructions by one or more processors is to cause the one or more processors to perform the method, techniques, or process as described in or related to any of examples 1-40, or portions thereof.

Example 53 may include a computer program comprising instructions, wherein execution of the program by a processing element is to cause the processing element to carry out the method, techniques, or process as described in or related to any of examples 1-40, or portions thereof.

Example 54 may include a signal in a wireless network as shown and described herein.

Example 55 may include a method of communicating in a wireless network as shown and described herein.

Example 56 may include a system for providing wireless communication as shown and described herein.

Example 57 may include a device for providing wireless communication as shown and described herein.

An example implementation is an edge computing system, including respective edge processing devices and nodes to invoke or perform the operations of the examples above, or other subject matter described herein. Another example implementation is a client endpoint node, operable to invoke or perform the operations of the examples above, or other subject matter described herein. Another example implementation is an aggregation node, network hub node, gateway node, or core data processing node, within or coupled to an edge computing system, operable to invoke or perform the operations of the examples above, or other subject matter described herein. Another example implementation is an access point, base station, road-side unit, street-side unit, or on-premise unit, within or coupled to an edge computing system, operable to invoke or perform the operations of the examples above, or other subject matter described herein. Another example implementation is an edge provisioning node, service orchestration node, application orchestration node, or multi-tenant management node, within or coupled to an edge computing system, operable to invoke or perform the operations of the examples above, or other subject matter described herein. Another example implementation is an edge node operating an edge provisioning service, application or service orchestration service, virtual machine deployment, container deployment, function deployment, and compute management, within or coupled to an edge computing system, operable to invoke or perform the operations of the examples above, or other subject matter described herein. Another example implementation is an edge computing system operable as an edge mesh, as an edge mesh with side car loading, or with mesh-to-mesh communications, operable to invoke or perform the operations of the examples above, or other subject matter described herein. Another example implementation is an edge computing system including aspects of network functions, acceleration functions, acceleration hardware, storage hardware, or computation hardware resources, operable to invoke or perform the use cases discussed herein, with use of the examples above, or other subject matter described herein. Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples above, or other subject matter described herein. Another example implementation is an edge computing system adapted for mobile wireless communications, including configurations according to an 3GPP 4G/LTE or 5G network capabilities, operable to invoke or perform the use cases discussed herein, with use of the examples above, or other subject matter described herein. Another example implementation is a computing system adapted for network communications, including configurations according to an O-RAN capabilities, operable to invoke or perform the use cases discussed herein, with use of the examples above, or other subject matter described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “In some embodiments,” which may each refer to one or more of the same or different embodiments. Furthermore, the terms “comprising,” “including,” “having,” and the like, as used with respect to embodiments of the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “memory” and/or “memory circuitry” as used herein refers to one or more hardware devices for storing data, including RAM, MRAM, PRAM, DRAM, and/or SDRAM, core memory, ROM, magnetic disk storage mediums, optical storage mediums, flash memory devices or other machine readable mediums for storing data. The term “computer-readable medium” may include, but is not limited to, memory, portable or fixed storage devices, optical storage devices, and various other mediums capable of storing, containing or carrying instructions or data.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource. The term “element” refers to a unit that is indivisible at a given level of abstraction and has a clearly defined boundary, wherein an element may be any type of entity including, for example, one or more devices, systems, controllers, network elements, modules, etc., or combinations thereof. The term “device” refers to a physical entity embedded inside, or attached to, another physical entity in its vicinity, with capabilities to convey digital information from or to that physical entity. The term “entity” refers to a distinct component of an architecture or device, or information transferred as a payload. The term “controller” refers to an element or entity that has the capability to affect a physical entity, such as by changing its state or causing the physical entity to move.

The term “cloud computing” or “cloud” refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like). The term “computing resource” or simply “resource” refers to any physical or virtual component, or usage of such components, of limited availability within a computer system or network. Examples of computing resources include usage/access to, for a period of time, servers, processor(s), storage equipment, memory devices, memory areas, networks, electrical power, input/output (peripheral) devices, mechanical devices, network connections (e.g., channels/links, ports, network sockets, etc.), operating systems, virtual machines (VMs), software/applications, computer files, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. As used herein, the term “cloud service provider” (or CSP) indicates an organization which operates typically large-scale “cloud” resources comprised of centralized, regional, and edge data centers (e.g., as used in the context of the public cloud). In other examples, a CSP may also be referred to as a Cloud Service Operator (CSO). References to “cloud computing” generally refer to computing resources and services offered by a CSP or a CSO, at remote locations with at least some increased latency, distance, or constraints relative to edge computing.

As used herein, the term “data center” refers to a purpose-designed structure that is intended to house multiple high-performance compute and data storage nodes such that a large amount of compute, data storage and network resources are present at a single location. This often entails specialized rack and enclosure systems, suitable heating, cooling, ventilation, security, fire suppression, and power delivery systems. The term may also refer to a compute and data storage node in some contexts. A data center may vary in scale between a centralized or cloud data center (e.g., largest), regional data center, and edge data center (e.g., smallest).

As used herein, the term “edge computing” refers to the implementation, coordination, and use of computing and resources at locations closer to the “edge” or collection of “edges” of a network. Deploying computing resources at the network's edge may reduce application and network latency, reduce network backhaul traffic and associated energy consumption, improve service capabilities, improve compliance with security or data privacy requirements (especially as compared to conventional cloud computing), and improve total cost of ownership). As used herein, the term “edge compute node” refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. References to a “node” used herein are generally interchangeable with a “device”, “component”, and “sub-system”; however, references to an “edge computing system” or “edge computing network” generally refer to a distributed architecture, organization, or collection of multiple nodes and devices, and which is organized to accomplish or offer some aspect of services or resources in an edge computing setting.

Additionally or alternatively, the term “Edge Computing” refers to a concept, as described in [6], that enables operator and 3rd party services to be hosted close to the UE's access point of attachment, to achieve an efficient service delivery through the reduced end-to-end latency and load on the transport network. As used herein, the term “Edge Computing Service Provider” refers to a mobile network operator or a 3rd party service provider offering Edge Computing service. As used herein, the term “Edge Data Network” refers to a local Data Network (DN) that supports the architecture for enabling edge applications. As used herein, the term “Edge Hosting Environment” refers to an environment providing support required for Edge Application Server's execution. As used herein, the term “Application Server” refers to application software resident in the cloud performing the server function.

The term “Internet of Things” or “IoT” refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities. “Edge IoT devices” may be any kind of IoT devices deployed at a network's edge.

As used herein, the term “cluster” refers to a set or grouping of entities as part of an edge computing system (or systems), in the form of physical entities (e.g., different computing systems, networks or network groups), logical entities (e.g., applications, functions, security constructs, containers), and the like. In some locations, a “cluster” is also referred to as a “group” or a “domain”. The membership of cluster may be modified or affected based on conditions or functions, including from dynamic or property-based membership, from network or system management scenarios, or from various example techniques discussed below which may add, modify, or remove an entity in a cluster. Clusters may also include or be associated with multiple layers, levels, or properties, including variations in security features and results based on such layers, levels, or properties.

The term “application” may refer to a complete and deployable package, environment to achieve a certain function in an operational environment. The term “AI/ML application” or the like may be an application that contains some AI/ML models and application-level descriptions. The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

The terms “instantiate,” “instantiation,” and the like as used herein refers to the creation of an instance. An “instance” also refers to a concrete occurrence of an object, which may occur, for example, during execution of program code. The term “information element” refers to a structural element containing one or more fields. The term “field” refers to individual contents of an information element, or a data element that contains content. As used herein, a “database object”, “data structure”, or the like may refer to any representation of information that is in the form of an object, attribute-value pair (AVP), key-value pair (KVP), tuple, etc., and may include variables, data structures, functions, methods, classes, database records, database fields, database entities, associations between data and/or database entities (also referred to as a “relation”), blocks and links between blocks in block chain implementations, and/or the like.

An “information object,” as used herein, refers to a collection of structured data and/or any representation of information, and may include, for example electronic documents (or “documents”), database objects, data structures, files, audio data, video data, raw data, archive files, application packages, and/or any other like representation of information. The terms “electronic document” or “document,” may refer to a data structure, computer file, or resource used to record data, and includes various file types and/or data formats such as word processing documents, spreadsheets, slide presentations, multimedia items, webpage and/or source code documents, and/or the like. As examples, the information objects may include markup and/or source code documents such as HTML, XML, JSON, Apex®, CSS, JSP, MessagePack™, Apache® Thrift™, ASN.1, Google® Protocol Buffers (protobuf), or some other document(s)/format(s) such as those discussed herein. An information object may have both a logical and a physical structure. Physically, an information object comprises one or more units called entities. An entity is a unit of storage that contains content and is identified by a name. An entity may refer to other entities to cause their inclusion in the information object. An information object begins in a document entity, which is also referred to as a root element (or “root”). Logically, an information object comprises one or more declarations, elements, comments, character references, and processing instructions, all of which are indicated in the information object (e.g., using markup).

The term “data item” as used herein refers to an atomic state of a particular object with at least one specific property at a certain point in time. Such an object is usually identified by an object name or object identifier, and properties of such an object are usually defined as database objects (e.g., fields, records, etc.), object instances, or data elements (e.g., mark-up language elements/tags, etc.). Additionally or alternatively, the term “data item” as used herein may refer to data elements and/or content items, although these terms may refer to difference concepts. The term “data element” or “element” as used herein refers to a unit that is indivisible at a given level of abstraction and has a clearly defined boundary. A data element is a logical component of an information object (e.g., electronic document) that may begin with a start tag (e.g., “<element>”) and end with a matching end tag (e.g., “</element>”), or only has an empty element tag (e.g., “<element/>”). Any characters between the start tag and end tag, if any, are the element's content (referred to herein as “content items” or the like).

The content of an entity may include one or more content items, each of which has an associated datatype representation. A content item may include, for example, attribute values, character values, URIs, qualified names (qnames), parameters, and the like. A qname is a fully qualified name of an element, attribute, or identifier in an information object. A qname associates a URI of a namespace with a local name of an element, attribute, or identifier in that namespace. To make this association, the qname assigns a prefix to the local name that corresponds to its namespace. The qname comprises a URI of the namespace, the prefix, and the local name. Namespaces are used to provide uniquely named elements and attributes in information objects. Content items may include text content (e.g., “<element>content item</element>”), attributes (e.g., “<element attribute=“attributeValue”>”), and other elements referred to as “child elements” (e.g., “<element1><element2>content item</element2></element1>”). An “attribute” may refer to a markup construct including a name-value pair that exists within a start tag or empty element tag. Attributes contain data related to its element and/or control the element's behavior.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable. The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information. As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like.

As used herein, the term “radio technology” refers to technology for wireless transmission and/or reception of electromagnetic radiation for information transfer. The term “radio access technology” or “RAT” refers to the technology used for the underlying physical connection to a radio based communication network. As used herein, the term “communication protocol” (either wired or wireless) refers to a set of standardized rules or instructions implemented by a communication device and/or system to communicate with other devices and/or systems, including instructions for packetizing/depacketizing data, modulating/demodulating signals, implementation of protocols stacks, and/or the like. Examples of wireless communications protocols may be used in various embodiments include a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology including, for example, 3GPP Fifth Generation (5G) or New Radio (NR), Universal Mobile Telecommunications System (UMTS), Freedom of Multimedia Access (FOMA), Long Term Evolution (LTE), LTE-Advanced (LTE Advanced), LTE Extra, LTE-A Pro, cdmaOne (2G), Code Division Multiple Access 2000 (CDMA 2000), Cellular Digital Packet Data (CDPD), Mobitex, Circuit Switched Data (CSD), High-Speed CSD (HSCSD), Universal Mobile Telecommunications System (UMTS), Wideband Code Division Multiple Access (W-CDM), High Speed Packet Access (HSPA), HSPA Plus (HSPA+), Time Division-Code Division Multiple Access (TD-CDMA), Time Division-Synchronous Code Division Multiple Access (TD-SCDMA), LTE LAA, MuLTEfire, UMTS Terrestrial Radio Access (UTRA), Evolved UTRA (E-UTRA), Evolution-Data Optimized or Evolution-Data Only (EV-DO), Advanced Mobile Phone System (AMPS), Digital AMPS (D-AMPS), Total Access Communication System/Extended Total Access Communication System (TACS/ETACS), Push-to-talk (PTT), Mobile Telephone System (MTS), Improved Mobile Telephone System (IMTS), Advanced Mobile Telephone System (AMTS), Cellular Digital Packet Data (CDPD), DataTAC, Integrated Digital Enhanced Network (iDEN), Personal Digital Cellular (PDC), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Bluetooth®, Bluetooth Low Energy (BLE), IEEE 802.15.4 based protocols (e.g., IPv6 over Low power Wireless Personal Area Networks (6LoWPAN), WirelessHART, MiWi, Thread, 802.11a, etc.) WiFi-direct, ANT/ANT+, ZigBee, Z-Wave, 3GPP device-to-device (D2D) or Proximity Services (ProSe), Universal Plug and Play (UPnP), Low-Power Wide-Area-Network (LPWAN), Long Range Wide Area Network (LoRA) or LoRaWAN™ developed by Semtech and the LoRa Alliance, Sigfox, Wireless Gigabit Alliance (WiGig) standard, Worldwide Interoperability for Microwave Access (WiMAX), mmWave standards in general (e.g., wireless systems operating at 10-300 GHz and above such as WiGig, IEEE 802.11ad, IEEE 802.11ay, etc.), V2X communication technologies (including 3GPP C-V2X), Dedicated Short Range Communications (DSRC) communication systems such as Intelligent-Transport-Systems (ITS) including the European ITS-G5, ITS-G5B, ITS-G5C, etc. In addition to the standards listed above, any number of satellite uplink technologies may be used for purposes of the present disclosure including, for example, radios compliant with standards issued by the International Telecommunication Union (ITU), or the European Telecommunications Standards Institute (ETSI), among others. The examples provided herein are thus understood as being applicable to various other communication technologies, both existing and not yet formulated.

The term “access network” refers to any network, using any combination of radio technologies, RATs, and/or communication protocols, used to connect user devices and service providers. In the context of WLANs, an “access network” is an IEEE 802 local area network (LAN) or metropolitan area network (MAN) between terminals and access routers connecting to provider services. The term “access router” refers to router that terminates a medium access control (MAC) service from terminals and forwards user traffic to information servers according to Internet Protocol (IP) addresses.

The term “SMTC” refers to an SSB-based measurement timing configuration configured by SSB-MeasurementTimingConfiguration. The term “SSB” refers to a synchronization signal/Physical Broadcast Channel (SS/PBCH) block, which includes a Primary Syncrhonization Signal (PSS), a Secondary Syncrhonization Signal (SSS), and a PBCH. The term “a “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “A1 policy” refers to a type of declarative policies expressed using formal statements that enable the non-RT RIC function in the SMO to guide the near-RT RIC function, and hence the RAN, towards better fulfilment of the RAN intent.

The term “A1 Enrichment information” refers to information utilized by near-RT RIC that is collected or derived at SMO/non-RT RIC either from non-network data sources or from network functions themselves.

The term “A1-Policy Based Traffic Steering Process Mode” refers to an operational mode in which the Near-RT RIC is configured through A1 Policy to use Traffic Steering Actions to ensure a more specific notion of network performance (for example, applying to smaller groups of E2 Nodes and UEs in the RAN) than that which it ensures in the Background Traffic Steering. The term “Background Traffic Steering Processing Mode” refers to an operational mode in which the Near-RT RIC is configured through O1 to use Traffic Steering Actions to ensure a general background network performance which applies broadly across E2 Nodes and UEs in the RAN.

The term “Baseline RAN Behavior” refers to the default RAN behavior as configured at the E2 Nodes by SMO

The term “E2” refers to an interface connecting the Near-RT RIC and one or more O-CU-CPs, one or more O-CU-UPs, one or more O-DUs, and one or more O-eNBs.

The term “E2 Node” refers to a logical node terminating E2 interface. In this version of the specification, ORAN nodes terminating E2 interface are: for NR access: O-CU-CP, O-CU-UP, O-DU or any combination; and for E-UTRA access: O-eNB.

The term “Intents”, in the context of O-RAN systems/implementations, refers to declarative policy to steer or guide the behavior of RAN functions, allowing the RAN function to calculate the optimal result to achieve stated objective.

The term “O-RAN non-real-time RAN Intelligent Controller” or “non-RT RIC” refers to a logical function that enables non-real-time control and optimization of RAN elements and resources, AI/ML workflow including model training and updates, and policy-based guidance of applications/features in Near-RT RIC.

The term “Near-RT RIC” or “O-RAN near-real-time RAN Intelligent Controller” refers to a logical function that enables near-real-time control and optimization of RAN elements and resources via fine-grained (e.g., UE basis, Cell basis) data collection and actions over E2 interface.

The term “O-RAN Central Unit” or “O-CU” refers to a logical node hosting RRC, SDAP and PDCP protocols.

The term “O-RAN Central Unit-Control Plane” or “O-CU-CP” refers to a logical node hosting the RRC and the control plane part of the PDCP protocol.

The term “O-RAN Central Unit-User Plane” or “O-CU-UP” refers to a logical node hosting the user plane part of the PDCP protocol and the SDAP protocol

The term “O-RAN Distributed Unit” or “O-DU” refers to a logical node hosting RLC/MAC/High-PHY layers based on a lower layer functional split.

The term “O-RAN eNB” or “O-eNB” refers to an eNB or ng-eNB that supports E2 interface.

The term “O-RAN Radio Unit” or “O-RU” refers to a logical node hosting Low-PHY layer and RF processing based on a lower layer functional split. This is similar to 3GPP's “TRP” or “RRH” but more specific in including the Low-PHY layer (FFT/iFFT, PRACH extraction).

The term “O1” refers to an interface between orchestration & management entities (Orchestration/NMS) and O-RAN managed elements, for operation and management, by which FCAPS management, Software management, File management and other similar functions shall be achieved.

The term “RAN UE Group” refers to an aggregations of UEs whose grouping is set in the E2 nodes through E2 procedures also based on the scope of A1 policies. These groups can then be the target of E2 CONTROL or POLICY messages.

The term “Traffic Steering Action” refers to the use of a mechanism to alter RAN behavior. Such actions include E2 procedures such as CONTROL and POLICY.

The term “Traffic Steering Inner Loop” refers to the part of the Traffic Steering processing, triggered by the arrival of periodic TS related KPM (Key Performance Measurement) from E2 Node, which includes UE grouping, setting additional data collection from the RAN, as well as selection and execution of one or more optimization actions to enforce Traffic Steering policies.

The term “Traffic Steering Outer Loop” refers to the part of the Traffic Steering processing, triggered by the near-RT RIC setting up or updating Traffic Steering aware resource optimization procedure based on information from A1 Policy setup or update, A1 Enrichment Information (EI) and/or outcome of Near-RT RIC evaluation, which includes the initial configuration (preconditions) and injection of related A1 policies, Triggering conditions for TS changes.

The term “Traffic Steering Processing Mode” refers to an operational mode in which either the RAN or the Near-RT RIC is configured to ensure a particular network performance. This performance includes such aspects as cell load and throughput, and can apply differently to different E2 nodes and UEs. Throughout this process, Traffic Steering Actions are used to fulfill the requirements of this configuration.

The term “Traffic Steering Target” refers to the intended performance result that is desired from the network, which is configured to Near-RT RIC over O1.

Furthermore, any of the disclosed embodiments and example implementations can be embodied in the form of various types of hardware, software, firmware, middleware, or combinations thereof, including in the form of control logic, and using such hardware or software in a modular or integrated manner. Additionally, any of the software components or functions described herein can be implemented as software, program code, script, instructions, etc., operable to be executed by processor circuitry. These components, functions, programs, etc., can be developed using any suitable computer language such as, for example, Python, PyTorch, NumPy, Ruby, Ruby on Rails, Scala, Smalltalk, Java™, C++, C#, “C”, Kotlin, Swift, Rust, Go (or “Golang”), EMCAScript, JavaScript, TypeScript, Jscript, ActionScript, Server-Side JavaScript (SSJS), PHP, Pearl, Lua, Torch/Lua with Just-In Time compiler (LuaJIT), Accelerated Mobile Pages Script (AMPscript), VBScript, JavaServer Pages (JSP), Active Server Pages (ASP), Node.js, ASP.NET, JAMscript, Hypertext Markup Language (HTML), extensible HTML (XHTML), Extensible Markup Language (XML), XML User Interface Language (XUL), Scalable Vector Graphics (SVG), RESTful API Modeling Language (RAML), wiki markup or Wikitext, Wireless Markup Language (WML), Java Script Object Notion (JSON), Apache® MessagePack™, Cascading Stylesheets (CSS), extensible stylesheet language (XSL), Mustache template language, Handlebars template language, Guide Template Language (GTL), Apache® Thrift, Abstract Syntax Notation One (ASN.1), Google® Protocol Buffers (protobuf), Bitcoin Script, EVM® bytecode, Solidity™, Vyper (Python derived), Bamboo, Lisp Like Language (LLL), Simplicity provided by Blockstream™, Rholang, Michelson, Counterfactual, Plasma, Plutus, Sophia, Salesforce® Apex®, and/or any other programming language or development tools including proprietary programming languages and/or development tools. The software code can be stored as a computer- or processor-executable instructions or commands on a physical non-transitory computer-readable medium. Examples of suitable media include RAM, ROM, magnetic media such as a hard-drive or a floppy disk, or an optical medium such as a compact disk (CD) or DVD (digital versatile disk), flash memory, and the like, or any combination of such storage or transmission devices.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

TABLE 3
Abbreviations:

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application Client |
| | Identification |
| AF | Application Function |
| AM | Acknowledged Mode |
| AMBR | Aggregate Maximum Bit |
| | Rate |
| AMF | Access and Mobility |
| | Management Function |
| AN | Access Network |
| ANR | Automatic Neighbour |
| | Relation |
| AP | Application Protocol, |
| | Antenna Port, Access Point |
| API | Application Programming |
| | Interface |
| APN | Access Point Name |
| ARP | Allocation and Retention |
| | Priority |
| ARQ | Automatic Repeat Request |
| AS | Access Stratum |
| ASP | Application Service |
| | Provider |
| ASN.1 | Abstract Syntax Notation |
| | One |
| AUSF | Authentication Server |
| | Function |
| AWGN | Additive White Gaussian |
| | Noise |
| BAP | Backhaul Adaptation |
| | Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access |
| | Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based Random |
| | Access |
| CC | Component Carrier, |
| | Country Code, |
| | Cryptographic Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple |
| | Access |
| CFRA | Contention Free Random |
| | Access |
| CG | Cell Group |
| CGF | Charging Gateway Function |
| CHF | Charging Function |
| CI | Cell Identity |
| CID | Ccll-ID (c.g., positioning |
| | method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile Alert |
| | Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic |
| | Prefix, Connection Point |
| CPD | Connection Point |
| | Descriptor |
| CPE | Customer Premise |
| | Equipment |
| CPICH | Common Pilot Channel |
| CQI | Channel Quality Indicator |
| CPU | CSI processing unit, Central |
| | Processing Unit |
| C/R | Command/Response field |
| | bit |
| CRAN | Cloud Radio Access |
| | Network, Cloud RAN |
| CRB | Common Resource Block |
| CRC | Cyclic Redundancy Check |
| CRI | Channel-State Information |
| | Resource Indicator, CSI-RS |
| | Resource Indicator |
| C-RNTI | Cell RNTI |
| CS | Circuit Switched |
| CSAR | Cloud Service Archive |
| CSI | Channel-State Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search Space, |
| | Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct |
| | Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, DMRS | Demodulation |
| | Reference Signal |
| DN | Data network |
| DNN | Data Network Name |
| DNAI | Data Network Access |
| | Identifier |
| DRB | Data Radio Bearer |
| DRS | Discovery Reference Signal |
| DRX | Discontinuous Reception |
| DSL | Domain Specific Language. |
| | Digital Subscriber Line |
| DSLAM | DSL Access Multiplexer |
| DwPTS | Downlink Pilot Time Slot |
| E-LAN | Ethernet Local Area |
| | Network |
| E2E | End-to-End |
| ECCA | extended clear channel |
| | assessment, extended CCA |
| ECCE | Enhanced Control Channel |
| | Element, Enhanced CCE |
| ED | Energy Detection |
| EDGE | Enhanced Datarates for |
| | GSM Evolution (GSM |
| | Evolution) |
| EAS | Edge Application Server |
| EASID | Edge Application Server |
| | Identification |
| ECS | Edge Configuration Server |
| ECSP | Edge Computing Service |
| | Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting Environment |
| EGMF | Exposure Governance |
| | tableManagement Function |
| EGPRS | Enhanced GPRS |
| EIR | Equipment Identity Register |
| eLAA | enhanced Licensed Assisted |
| | Access, enhanced |
| | LAA |
| EM | Element Manager |
| eMBB | Enhanced Mobile |
| | Broadband |
| EMS | Element Management |
| | System |
| eNB | evolved NodeB, E-UTRAN |
| | Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, enhanced |
| | resource element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier Transformation |
| feLAA | further enhanced Licensed |
| | Assisted Access, further |
| | enhanced LAA |
| FN | Frame Number |
| FPGA | Field-Programmable Gate |
| | Array |
| FR | Frequency Range |
| FQDN | Fully Qualified Domain |
| | Name |
| G-RNTI | GERAN Radio Network |
| | Temporary Identity |
| GERAN | GSM EDGE RAN, GSM |
| | EDGE Radio Access |
| | Network |
| GGSN | Gateway GPRS Support |
| | Node |
| GLONASS | GLObal'naya |
| | NAvigatsionnaya |
| | Sputnikovaya Sistema |
| | (Engl .: Global Navigation |
| | Satellite System) |
| gNB | Next Generation NodeB |
| gNB-CUg | NB-centralized unit, Next |
| | Generation NodeB |
| | centralized unit |
| gNB-DUg | NB-distributed unit, Next |
| | Generation NodeB |
| | distributed unit |
| GNSS | Global Navigation Satellite |
| | System |
| GPRS | General Packet Radio |
| | Service |
| GPSI | Generic Public Subscription |
| | Identifier |
| GSM | Global System for Mobile |
| | Communications, Groupe |
| | Special Mobile |
| GTP | GPRS Tunneling Protocol |
| GTP-U | GPRS Tunnelling Protocol |
| | for User Plane |
| GTS | Go To Sleep Signal (related |
| | to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile |
| | Network |
| HSDPA | High Speed Downlink |
| | Packet Access |
| HSN | Hopping Sequence Number |
| HSPA | High Speed Packet Access |
| HSS | Home Subscriber Server |
| HSUPA | High Speed Uplink Packet |
| | Access |
| HTTP | Hyper Text Transfer |
| | Protocol |
| HTTPS | Hyper Text Transfer |
| | Protocol Secure (https is |
| | http/1.1 over SSL, i.e. port |
| | 443) |
| I-Block | Information Block |
| ICCID | Integrated Circuit Card |
| | Identification |
| IAB | Integrated Access and |
| | Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI | IP Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, Internet |
| | Protocol Security |
| IP-CAN | IP-Connectivity Access |
| | Network |
| IP-M | IP Multicast |
| IPV4 | Internet Protocol |
| | Version 4 |
| IPV6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of the |
| | convolutional code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal |
| | received power |
| L2 | Layer 2 (data link layer) |
| L3 | Layer 3 (network layer) |
| LAA | Licensed Assisted |
| | Access |
| LAN | Local Area Network |
| LADN | Local Area Data |
| | Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term Evolution |
| M2M | Machine-to-Machine |
| MAC | Medium Access Control |
| | (protocol layering |
| | context) |
| MAC | Message authentication |
| | code |
| | (security/encryption |
| | context) |
| MAC-A | MAC used for |
| | authentication and key |
| | agreement (TSG T WG3 |
| | context) |
| MAC-I | MAC used for data |
| | integrity of signalling |
| | messages (TSG T WG3 |
| | context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of Drive |
| | Tests |
| ME | Mobile Equipment |
| MeNB | master eNB |
| MER | Message Error Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input Multiple |
| | Output |
| MLC | Mobile Location Centre |
| MM | Mobility Management |
| MME | Mobility Management |
| | Entity |
| MN | Master Node |
| MNO | Mobile Network |
| | Operator |
| MO | Measurement Object, |
| | Mobile Originated |
| MPBCH | MTC Physical |
| | Broadcast CHannel |
| MPDCCH | MTC Physical |
| | Downlink Control |
| | CHannel |
| MPDSCH | MTC Physical |
| | Downlink Shared |
| | CHannel |
| MPRACH | MTC Physical Random |
| | Access CHannel |
| MPUSCH | MTC Physical Uplink |
| | Shared Channel |
| MPLS | MultiProtocol Label |
| | Switching |
| MS | Mobile Station |
| MSB | Most Significant Bit |
| MSC | Mobile Switching |
| | Centre |
| MSI | Minimum System |
| | Information, MCH |
| | Scheduling Information |
| MSID | Mobile Station Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum |
| | layer |
| NCT | Network Connectivity |
| | Topology |
| NC-JT | Non-Coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding |
| | Path |
| NFPD | Network Forwarding |
| | Path Descriptor |
| NFV | Network Functions |
| | Virtualization |
| NFVI | NFV Infrastructure |
| NFVO | NFV Orchestrator |
| NG | Next Generation, Next |
| | Gen |
| NGEN-DC | NG-RAN E-UTRA- |
| | NR Dual Connectivity |
| NM | Network Manager |
| NMS | Network Management |
| | System |
| N-POP | Network Point of |
| | Presence |
| NMIB, N-MIB | Narrowband MIB |
| NPBCH | Narrowband Physical |
| | Broadcast CHannel |
| NPDCCH | Narrowband Physical |
| | Downlink Control |
| | CHannel |
| NPDSCH | Narrowband Physical |
| | Downlink Shared |
| | CHannel |
| NPRACH | Narrowband Physical |
| | Random Access |
| | CHannel |
| NPUSCH | Narrowband Physical |
| | Uplink Shared CHannel |
| NPSS | Narrowband Primary |
| | Synchronization Signal |
| NSSS | Narrowband Secondary |
| | Synchronization Signal |
| NR | New Radio, Neighbour |
| | Relation |
| NRF | NF Repository Function |
| NRS | Narrowband Reference |
| | Signal |
| NS | Network Service |
| NSA | Non-Standalone |
| | operation mode |
| NSD | Network Service |
| | Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up |
| | signal, Narrowband |
| | WUS |
| NZP | Non-Zero Power |
| O&M | Operation and |
| | Maintenance |
| ODU2 | Optical channel Data |
| | Unit - type 2 |
| OFDM | Orthogonal Frequency |
| | Division Multiplexing |
| OFDMA | Orthogonal Frequency |
| | Division Multiple |
| | Access |
| OOB | Out-of-band |
| OOS | Out of Sync |
| OPEX | OPerating EXpense |
| OSI | Other System |
| | Information |
| OSS | Operations Support |
| | System |
| OTA | over-the-air |
| PAPR | Peak-to-Average Power |
| | Ratio |
| PAR | Peak to Average Ratio |
| PBCH | Physical Broadcast |
| | Channel |
| PC | Power Control, Personal |
| | Computer |
| PCC | Primary Component |
| | Carrier, Primary CC |
| PCell | Primary Cell |
| PCI | Physical Cell ID, |
| | Physical Cell Identity |
| PCEF | Policy and Charging |
| | Enforcement Function |
| PCF | Policy Control Function |
| PCRF | Policy Control and |
| | Charging Rules Function |
| PDCP | Packet Data |
| | Convergence Protocol, |
| | Packet Data |
| | Convergence Protocol |
| | layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance |
| | Measurement |
| PMI | Precoding Matrix |
| | Indicator |
| PNF | Physical Network |
| | Function |
| PNFD | Physical Network |
| | Function Descriptor |
| PNFR | Physical Network |
| | Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block |
| | group |
| ProSe | Proximity Services, |
| | Proximity-Based |
| | Service |
| PRS | Positioning Reference |
| | Signal |
| PRR | Packet Reception Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization Signal |
| PSTN | Public Switched |
| | Telephone Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS Flow |
| | Identifier |
| QoS | Quality of Service |
| QPSK | Quadrature (Quaternary) |
| | Phase Shift Keying |
| QZSS | Quasi-Zenith Satellite |
| | System |
| RA-RNTI | Random Access RNTI |
| RAB | Radio Access Bearer, |
| Random | Access Burst |
| RACH | Random Access Channel |
| RADIUS | Remote Authentication |
| | Dial In User Service |
| RAN | Radio Access Network |
| RAND | RANDom number (used |
| | for authentication) |
| RAR | Random Access Response |
| RAT | Radio Access |
| | Technology |
| RAU | Routing Area Update |
| RB | Resource block, Radio |
| | Bearer |
| RBG | Resource block group |
| REG | Resource Element |
| | Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control |
| | layer |
| RLC | AM RLC Acknowledged |
| | Mode |
| RLC UM | RLC Unacknowledged |
| | Mode |
| RLF | Radio Link Failure |
| RLM | Radio Link Monitoring |
| RLM-RS | Reference Signal for |
| | RLM |
| RM | Registration |
| | Management |
| RMC | Reference Measurement |
| | Channel |
| RMSI | Remaining MSI, |
| | Remaining Minimum |
| | System Information |
| RN | Relay Node |
| RNC | Radio Network |
| | Controller |
| RNL | Radio Network Layer |
| RNTI | Radio Network |
| | Temporary Identifier |
| ROHC | RObust Header |
| | Compression |
| RRC | Radio Resource Control, |
| | Radio Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Rccciving, |
| | Receiver |
| S1AP | S1 Application Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary Mobile |
| | Station Identifier |
| SA | Standalone operation |
| | mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission Protocol |
| SDAP | Service Data Adaptation |
| | Protocol, Service Data |
| | Adaptation Protocol |
| | layer |
| SDL | Supplementary |
| | Downlink |
| SDNF | Structured Data Storage |
| | Network Function |
| SDP | Session Description |
| | Protocol |
| SDSF | Structured Data Storage |
| | Function |
| SDU | Service Data Unit |
| SEAF | Security Anchor |
| | Function |
| SeNB | secondary eNB |
| SEPP | Security Edge Protection |
| | Proxy |
| SFI | Slot format indication |
| SFTD | Space-Frequency Time |
| | Diversity, SFN and |
| | frame timing difference |
| SFN | System Frame Number |
| SgNB | Secondary gNB |
| SGSN | Serving GPRS Support |
| | Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent CSI |
| | RNTI |
| SPS | Semi-Persistent |
| | Scheduling |
| SQN | Sequence number |
| SR | Scheduling Request |
| SRB | Signalling Radio Bearer |
| SRS | Sounding Reference |
| | Signal |
| SS | Synchronization Signal |
| SSB | Synchronization Signal |
| | Block |
| SSID | Service Set Identifier |
| SS/PBCH | Block |
| SSBRI | SS/PBCH Block |
| | Resource Indicator, |
| | Synchronization Signal |
| | Block Resource |
| | Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise |
| | and Interference Ratio |
| SSS | Secondary |
| | Synchronization Signal |
| SSSG | Search Space Sct Group |
| SSSIF | Search Space Set |
| | Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division Duplex |
| TDM | Time Division |
| | Multiplexing |
| TDMA | Time Division Multiple |
| | Access |
| TE | Terminal Equipment |
| TEID | Tunnel End Point |
| | Identifier |
| TFT | Traffic Flow Template |
| TMSI | Temporary Mobile |
| | Subscriber Identity |
| TNL | Transport Network |
| | Layer |
| TPC | Transmit Power Control |
| TPMI | Transmitted Precoding |
| | Matrix Indicator |
| TR | Technical Report |
| TRP, TRxP | Transmission |
| | Reception Point |
| TRS | Tracking Reference |
| | Signal |
| TRx | Transceiver |
| TS | Technical |
| | Specifications, |
| | Technical Standard |
| TTI | Transmission Time |
| | Interval |
| Tx | Transmission, |
| | Transmitting, |
| | Transmitter |
| U-RNTI | UTRAN Radio Network |
| | Temporary Identity |
| UART | Universal Asynchronous |
| | Receiver and |
| | Transmitter |
| UCI | Uplink Control |
| | Information |
| UE | User Equipment |
| UDM | Unified Data |
| | Management |
| UDP | User Datagram Protocol |
| UDSF | Unstructured Data |
| | Storage Network |
| | Function |
| UICC | Universal Integrated |
| | Circuit Card |
| UL | Uplink |
| UM | Unacknowledged Mode |
| UML | Unified Modelling |
| | Language |
| UMTS | Universal Mobile |
| | Telecommunications |
| | System |
| UP | User Plane |
| UPF | User Plane Function |
| URI | Uniform Resource |
| | Identifier |
| URL | Uniform Resource |
| | Locator |
| URLLC | Ultra-Reliable and Low |
| | Latency |
| USB | Universal Serial Bus |
| USIM | Universal Subscriber |
| | Identity Module |
| USS | UE-specific search space |
| UTRA | UMTS Terrestrial Radio |
| | Access |
| UTRAN | Universal Terrestrial |
| | Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized Network |
| | Function |
| VNFFG | VNF Forwarding Graph |
| VNFFGD | VNF Forwarding Graph |
| | Descriptor |
| VNFM | VNF Manager |
| VOIP | Voice-over-IP, Voice- |
| | over-Internet Protocol |
| VPLMN | Visited Public Land |
| | Mobile Network |
| VPN | Virtual Private Network |
| VRB | Virtual Resource Block |
| WiMAX | Worldwide |
| | Interoperability for |
| | Microwave Access |
| WLAN | Wireless Local Area |
| | Network |
| WMAN | Wireless Metropolitan |
| | Area Network |
| WPAN | Wireless Personal Area |
| | Network |
| X2-C | X2-Control plane |
| X2-U | X2-User plane |
| XML | extensible Markup |
| | Language |
| XRES | Expected user |
| | RESponse |
| XOR | exclusive OR |
| ZC | Zadoff-Chu |
| ZP | Zero Po |

The foregoing description provides illustration and description of various example embodiments, but is not intended to be exhaustive or to limit the scope of embodiments to the precise forms disclosed. Modifications and variations are possible in light of the above teachings or may be acquired from practice of various embodiments. Where specific details are set forth in order to describe example embodiments of the disclosure, it should be apparent to one skilled in the art that the disclosure can be practiced without, or with variation of, these specific details. It should be understood, however, that there is no intent to limit the concepts of the present disclosure to the particular forms disclosed, but on the contrary, the intention is to cover all modifications, equivalents, and alternatives consistent with the present disclosure and the appended claims.

What is claimed is:

1. An apparatus for a network node comprising:
discover a Network Data Analytics Function (NWDAF) via a Network Function Repository Function (NRF);
send an Analytics request or subscribe to the selected NWDAF with a criteria based on a sensing data analytics ID, event ID, and event parameters;
select a Data Collection Coordination Function (DCCF) instance when DCCF is used for data collection, based on DCCF Serving Area Information; and
receive sensing data or data analytics from the NWDAF after NWDAF has processed the data collected from DCCF.

2. The apparatus of claim 1, wherein the discovery and selection of the NWDAF is based on an Analytics ID for sensing service, supported services, NWDAF capabilities, or NWDAF serving area information.

3. The apparatus of claim 1, wherein the processing circuitry is further configured to determine the NWDAF based on supported analytics registered with DCCF or NRF.

4. The apparatus of claim 1, wherein the Event ID comprises one of Sensing Target Status Update, Sensing Target Mobility, Sensing Configuration Update, Sensing Capability Update, or Sensing Quality of Service Update.

5. The apparatus of claim 1, wherein the processing circuitry is further configured to specify a reporting endpoint for the analytics, such as an Application Function (AF).

6. The apparatus of claim 1, wherein the processing circuitry is further configured to send a Nnwdaf_AnalyticsSubsription_Subscribe message to the NWDAF.

7. The apparatus of claim 1, wherein the processing circuitry is further configured to receive a Nnwdaf_AnalyticsSubscription_Notify comprising the sensing data or generated data analytics.

8. The apparatus of claim 1, wherein the processing circuitry is further configured to send a request to the DCCF with a criteria of the sensing data or analytics based on the sensing data analytics ID, event ID, and event parameters.

9. The apparatus of claim 7, wherein the processing circuitry is further configured to trigger the SSMF or other sensing data and data analytics consumer to subscribe with the NWDAF to receive Sensing Service analytics.

10. The apparatus of claim 1, wherein the interfaces between SSMF and DCCF, SSMF and NWDAF, SSMF and ADRF are NS5, NS6, and NS7, respectively.

11. A non-transitory computer-readable medium storing computer-executable instructions which when executed by one or more processors result in performing operations comprising:
discovering a Network Data Analytics Function (NWDAF) via a Network Function Repository Function (NRF);
sending an Analytics request or subscribe to the selected NWDAF with a criteria based on a sensing data analytics ID for sensing service, event ID, and event parameters;
selecting a Data Collection Coordination Function (DCCF) instance when DCCF is used for data collection, based on DCCF Serving Area Information; and
receiving sensing data or data analytics from the NWDAF after NWDAF has processed the data collected from DCCF.

12. The non-transitory computer-readable medium of claim 11, wherein the discovery and selection of the NWDAF is based on an Analytics ID for sensing service, supported services, NWDAF capabilities, or NWDAF serving area information.

13. The non-transitory computer-readable medium of claim 11, wherein the operations further comprise determining the NWDAF based on supported analytics registered with DCCF or NRF.

14. The non-transitory computer-readable medium of claim 11, wherein the Event ID comprises one of Sensing Target Status Update, Sensing Target Mobility, Sensing Configuration Update, Sensing Capability Update, or Sensing Quality of Service Update.

15. The non-transitory computer-readable medium of claim 11, wherein the operations further comprise specifying a reporting endpoint for the analytics, such as an Application Function (AF).

16. The non-transitory computer-readable medium of claim 11, wherein the operations further comprise sending a Nnwdaf_AnalyticsSubsription_Subscribe message to the NWDAF.

17. The non-transitory computer-readable medium of claim 11, wherein the operations further comprise receiving a Nnwdaf_AnalyticsSubscription_Notify comprising the sensing data or data analytics.

18. The non-transitory computer-readable medium of claim 11, wherein the interfaces between SSMF and DCCF, SSMF and NWDAF, SSMF and ADRF are NS5, NS6, and NS7, respectively.

19. A method comprising:
discovering a Network Data Analytics Function (NWDAF) via a Network Function Repository Function (NRF);
sending an Analytics request or subscribe to the selected NWDAF with a criteria based on a sensing data analytics ID for sensing service, event ID, and event parameters;
selecting a Data Collection Coordination Function (DCCF) instance when DCCF is used for data collection, based on DCCF Serving Area Information; and
receiving sensing data or data analytics from the NWDAF after NWDAF has processed the data collected from DCCF.

20. The method of claim 19, wherein the discovery and selection of the NWDAF is based on an Analytics ID for sensing service, supported services, NWDAF capabilities, or NWDAF serving area information.
